(19) United States
(12) Patent Application Publication
(10) Pub. No.: US 2021/0239955 A1
(43) Pub. Date: Aug. 5, 2021

(54) NEAR INFRA-RED LIGHT SHEET MICROSCOPY THROUGH SCATTERING TISSUES

(71) Applicant: The Board of Trustees of the Leland Stanford Junior University, Stanford, CA (US)

(72) Inventors: Hongjie DAI, Cupertino, CA (US); Feifei WANG, Palo Alto, CA (US)

(21) Appl. No.: 16/972,151

(22) PCT Filed: Jun. 4, 2019
(86) PCT No.: PCT/US19/35346

§ 371 Date: Dec. 4, 2020

Related U.S. Application Data
(60) Provisional application No. 62/682,322, filed on Jun. 8, 2018.
(60) Provisional application No. 62/828,728, filed on Apr. 3, 2019.

(51) Int. Cl. G02B 21/00; G02B 21/36; G02B 21/02; G01N 21/64; G02B 5/20

(52) U.S. Cl. CPC G02B 21/0032; G02B 21/0076; G02B 21/367; G02B 21/02; G01N 2333/70553; G01N 21/6428; G02B 5/208; G01N 2333/70596; G01N 21/6458

(57) ABSTRACT

Provided are methods of near-infrared II light sheet microscopy with excitation and emission up to between about 1320 nm and about 2400 nm, respectively, for optical sectioning through live tissues with improved penetration depth without any invasive surgery. The methods allow for normal and oblique configurations enabled in vivo imaging of live mice through intact tissue, revealing such as abnormal blood flow and T cell motion in tumor microcirculation and mapping out programmed-death ligand 1 and programmed cell death protein 1 (PD-1) in tumors with cellular resolution. 3D imaging through intact mouse heads resolved vascular channels between skull and brain cortex, and monitored recruitment of macrophages/microglia to traumatic brain injury site post injury.

### CROSS-REFERENCE TO RELATED APPLICATIONS

This application claims priority to and the benefit of U.S. Provisional Application 62/682,322 titled “NEAR INFRA-RED LIGHT SHEET MICROSCOPY THROUGH SCATTERING TISSUES” filed Jun. 8, 2018 and to U.S. Provisional Application 62/828,728 titled “LIGHT SHEET MICROSCOPY IN THE NEAR-INFRARED II WINDOW” filed Apr. 3, 2019, the entire disclosures of which are incorporated herein by reference in their entireties.

### STATEMENT ON FUNDING PROVIDED BY THE U.S. GOVERNMENT

This invention was made with Government support under contracts NS105737 awarded by the National Institutes of Health. The Government has certain rights in the invention.

### TECHNICAL FIELD

The present disclosure is generally related to methods of imaging tissues using near infra-red light sheet microscopy. The present disclosure is further generally related to an optical system for near infra-red light sheet microscopy.

### BACKGROUND

Optical imaging of biological systems capable of high spatiotemporal resolution in vivo and ex vivo has revolutionized biology and medicine for visualization and understanding of structures, functions and dynamic processes at the cellular, and even molecular, scale (Jain, R. K. Cancer Cell 26: 605-622 (2014); Liu et al., Science 360: eaaq1392 (2018)). To circumvent light scattering by tissues, in vivo 3D imaging by non-linear two-photon fluorescence microscopy (670-1070 nm excitation) (Helmchen & Denk. Nat. Methods 2: 932-940 (2005); Lapadula et al., Chem. Mater. 26: 1062-1073 (2014); Alifu et al., Dyes Pigments 143: 76-85 (2017)) or three-photon microscopy (1300-1700 nm excitation) (Horton et al., Nat. Photonics 7: 205-209 (2013); Ouzounov et al., Nat. Methods 14: 388-390 (2017); Rowlands et al., Light-Sci. Appl. 6: e16255 (2017); Liu et al., Biomed. Opt. Express 6: 1857-1866 (2015)) has reached penetration depths of approximately 0.7-1.5 mm, benefiting from increased scattering mean free path of the near-infrared (NIR) excitation used (Horton et al., Nat. Photonics 7: 205-209 (2013)).

Light sheet microscopy (LSM) uses orthogonally arranged planar illumination and wide-field detection, capable of high speed 3D optical sectioning, low photo-damage (Huisken et al., Science 305: 1007-1009 (2004); Dodt et al., Nat. Methods 4: 331-336 (2007)) and volumetrically imaging/tracking with subcellular resolution (Liu et al., Science 360: eaaq1392 (2018)). Currently the excitation and emission of LSM are mostly in the visible range except for two photon excitation in the NIR at approximately 940 nm (Truong et al., Nat. Methods 8: 757-U102 (2011)) or three photon excitation at 1000 nm (Escobet-Montalbán et al., Opt. Lett. 43: 5484-5487 (2018)). Light scattering has limited use of LSM to imaging small transparent animals, organisms (zebrafish larvae, Drosophila larvae, Medaka embryo, C. elegans, etc.), mammalian tissue samples after chemical clearing (Dodt et al., Nat. Methods 4: 331-336 (2007); Chung et al., Nature 497: 332-337 (2013); Tomer et al., Nat. Protoc. 9: 1682-1697 (2014)), and mouse brain at a depth of approximately 200 μm after craniotomy (Bouchard et al., Nat. Photonics 9: 113 (2015)).

Several classes of fluorescence probes have been developed with emission in the NIR-II window (1000-1700 nm) including carbon nanotubes, quantum dots, organic conjugated polymers and molecular dyes, and rare-earth nanoparticles (Welsher et al., Nat. Nanotechnol. 4: 773-780 (2009); Welsher et al., Proc. Natl. Acad. Sci. USA 108: 8943-8948 (2011); Hong et al., Nat. Med. 18: 1841-1846 (2012); Hong et al., Nat. Photonics 8: 723-730 (2014); Hong et al., Nat. Commun. 5: 4206 (2014); Diao et al., Angew. Chem. Int. Edit. 54: 14758-14762 (2015); Diao et al., Nano Res. 8: 3027-3034 (2015); Antaris et al., Nat. Mater. 15: 235-242 (2016); Zhong et al., Nat. Commun. 8: 737 (2017); Won et al., Mol. Imaging. 11: 338-352 (2012); Naczynski et al., Nat. Commun. 4: 2199 (2013); Wan et al., Nat. Commun. 9: 1171 (2018); Zhang et al., Proc. Natl. Acad. Sci. USA 115: 6590-6595 (2018); Bruns et al., Nat. Biomed. Eng. 1: 0056 (2017)). With suppressed photon scattering and diminished autofluorescence in the long-wavelength region, these probes have facilitated one-photon wide-field (Welsher et al., Nat. Nanotechnol. 4: 773-780 (2009); Welsher et al., Proc. Natl. Acad. Sci. USA 108: 8943-8948 (2011); Hong et al., Nat. Med. 18: 1841-1846 (2012); Hong et al., Nat. Photonics 8: 723-730 (2014); Hong et al., Nat. Commun. 5: 4206 (2014); Diao et al., Angew. Chem. Int. Edit. 54: 14758-14762 (2015); Diao et al., Nano Res. 8: 3027-3034 (2015); Antaris et al., Nat. Mater. 15: 235-242 (2016); Zhong et al., Nat. Commun. 8: 737 (2017); Won et al., Mol. Imaging. 11: 338-352 (2012); Naczynski et al., Nat. Commun. 4: 2199 (2013)) or confocal (Wan et al., Nat. Commun. 9: 1171 (2018); Zhang et al., Proc. Natl. Acad. Sci. USA 115: 6590-6595 (2018)) fluorescence imaging in the NIR-II window for mouse models of cardiovascular and brain diseases and cancer (Hong et al., Nat. Photonics 8: 723-730 (2014); Wan et al., Nat. Commun. 9: 1171 (2018); Bruns et al., Nat. Biomed. Eng. 1: 0056 (2017)). Non-invasive imaging through the skin, skull and body tissues was achieved, with deep penetration depths and high signal-to-background ratio (SBR).

### SUMMARY

One aspect of the disclosure, therefore, encompasses embodiments of a method of optically sectioning a biological sample, the method comprising the steps: (a) contacting a biological sample with a fluorescent contrast agent having an excitation wavelength of between about 785 nm to about 2400 nm and a fluorescence emission having a wavelength of between about 800 nm to about 2400 nm; (b) irradiating the biological sample with at least one excitation light having a wavelength of between about 785 nm to about 2400 nm, wherein the excitation light is configured as a static light sheet and directed through a first plane of the biological sample; (c) orthogonally detecting an emitted fluorescence having a wavelength of between about 800 nm to about 2400 nm from the irradiated biological sample; and (d) generating a first digital image of the fluorescence from the irradiated first plane through the biological sample.

In embodiments of this aspect of the disclosure, the biological sample can be an isolated cell or population of isolated cells, a cultured cell or population of cultured cells, an isolated tissue or organ, or an animal or human subject.

In some embodiments of this aspect of the disclosure, the biological sample has raised features and the irradiated biological sample is imaged by transmitting the light sheet through the raised feature from a side thereof and detecting the emitted fluorescence at right angles to the plane of the illuminating light sheet.

In some embodiments of this aspect of the disclosure, the biological sample can have substantially planar regions and the irradiated biological sample can be illuminated by the light sheet at an angle with respect to the normal to the planar region and the emitted fluorescence is detected at right angles to the plane of the illuminating light sheet.

In some embodiments of this aspect of the disclosure, the fluorescent contrast agent can be administrated by vascular delivery to a tissue or organ of the animal or human subject.

In some embodiments of this aspect of the disclosure, the fluorescent contrast agent can be conjugated to a targeting ligand that can specifically bind to a molecular target.

In some embodiments of this aspect of the disclosure, the targeting ligand can have an affinity for a molecular target and is selected from an antibody, a peptide, an aptamer, or a nucleic acid.

In some embodiments of this aspect of the disclosure, the targeting ligand can be an antibody or fragment thereof selectively binding to an epitope of a polypeptide selected from the group consisting of: Programmed cell death protein 1 (PD-1), Programmed death-ligand 1 (PD-L1), and CD11b.

In some embodiments of this aspect of the disclosure, the fluorescent contrast agent can emit at a wavelength of between about 900 to about 2400 nm and can be an organic molecular dye, a conjugated polymeric dye, a polymer micelle-wrapped organic nanofluorophore, a carbon nanotube, a quantum dot, or a rare-earth down-conversion or up-conversion nanoparticle.

In some embodiments of this aspect of the disclosure, the method can further comprise the steps: (i) repeating steps (b)-(d), thereby irradiating a plurality of parallel planes perpendicular to the light sheet plane at various depths through the biological sample, and generating a plurality of digital images; and (ii) digitally combining the plurality of digital images to generate a three-dimensional image of the location of the fluorescence emitted by the contrast agent in the biological sample.

In some embodiments of this aspect of the disclosure, the excitation light can be delivered to biological sample by an illumination objective, wherein the numerical aperture (N.A) of the objective is configured to deliver the excitation light as a light sheet having a balanced waist thickness of between about 5 μm to about 20 μm and a Rayleigh length of between about 0.1 mm to about 6.0 mm.

In some embodiments of this aspect of the disclosure, the excitation light can be generated by a laser having a wavelength of between about 700 nm and about 2400 nm. Another aspect of the disclosure encompasses embodiments of a light sheet microscope comprising along an optical axis: an illumination objective positioned to direct an excitation light sheet through a plane of a biological sample; a plurality of achromatic lenses optimized for transmission of light between about 785 nm to about 2400 nm; a proximal first adjustable mechanical slit; a cylindrical lens; a distal second adjustable mechanical slit adjacent to the cylindrical lens and distal to the illumination objective, wherein the slit of said second slit is orientated at right-angles to the slit of the first slit; a pinhole; at least one excitation light source in the 600-2400 nm range; and at least one removable mirror disposed to direct an excitation light from the at least one light source along the optical axis of the illumination objective, the plurality of achromatic lenses, the proximal first adjustable mechanical slit, the cylindrical lens, the distal second adjustable mechanical slit, and the pinhole; a detection objective disposed to orthogonally receive fluorescent light emitted from a target irradiated by a light sheet from the illumination objective and to direct said fluorescent light to a detector operably connected to a computer system for generating a digital image of the fluorescent light; and at least one emission filter configured to only transmit fluorescent light having a wavelength of between about 785 nm to about 2400 nm.

In some embodiments of this aspect of the disclosure, the light sheet microscope can further comprise a right-angle prism disposed between the biological sample and the illuminating and receiving lenses.

In some embodiments of this aspect of the disclosure, when the illuminating light sheet is configured to illuminate the biological sample at an angle of less than 90° between a tangential plane of the biological sample and the illuminating light sheet, a solid, liquid or gas having a refractive index of about that of the biological sample can be disposed between the biological sample and the illuminating and receiving lenses.

In some embodiments of this aspect of the disclosure, the excitation light source can further comprise a shortpass filter to select the excitation wavelength.

In some embodiments of this aspect of the disclosure, the excitation light source can be a laser.

In some embodiments of this aspect of the disclosure, the excitation light source can emit an excitation light having a wavelength of between about 785 nm and 2400 nm.

In some embodiments of this aspect of the disclosure, the detector can be sensitive to light having a wavelength of between about 800 nm and about 2400 nm.

In some embodiments of this aspect of the disclosure, the detector can be an InGaAs camera sensitive to light having a wavelength of between about 800 nm and about 2400 nm.

In some embodiments of this aspect of the disclosure, the detector can be a small bandgap semiconductor-based camera sensitive to light having a wavelength of between about 800 nm to about 2400 nm.

### BRIEF DESCRIPTION OF THE DRAWINGS

Further aspects of the present disclosure will be more readily appreciated upon review of the detailed description of its various embodiments, described below, when taken in conjunction with the accompanying drawings.

FIGS. 1A-1F illustrate light sheet microscopy in various NIR 850-1700 nm emission sub-regions.

FIG. 1A illustrates a simplified schematic of the NIR LSM.

FIG. 1B illustrates a fluorescence emission spectra of p-FE and PEGylated PbS/CdS core/shell quantum dots (see FIGS. 7A and 7B for excitation spectra).

FIG. 10 illustrates light-sheet optical sectioning mouse brain vasculatures at various depths in NIR-I, NIR-IIa and NIR-IIb emission regions using the same 785 nm light sheet illumination. Scale bars are 100 μm.

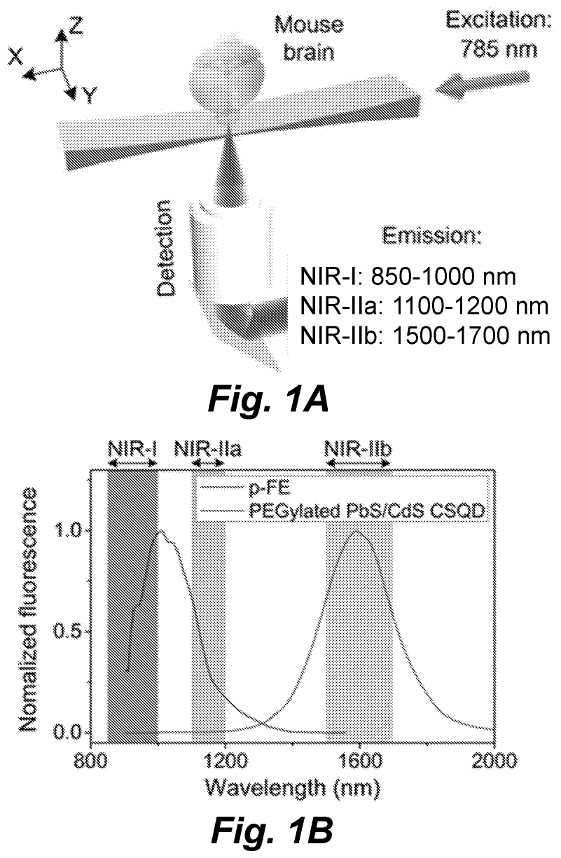

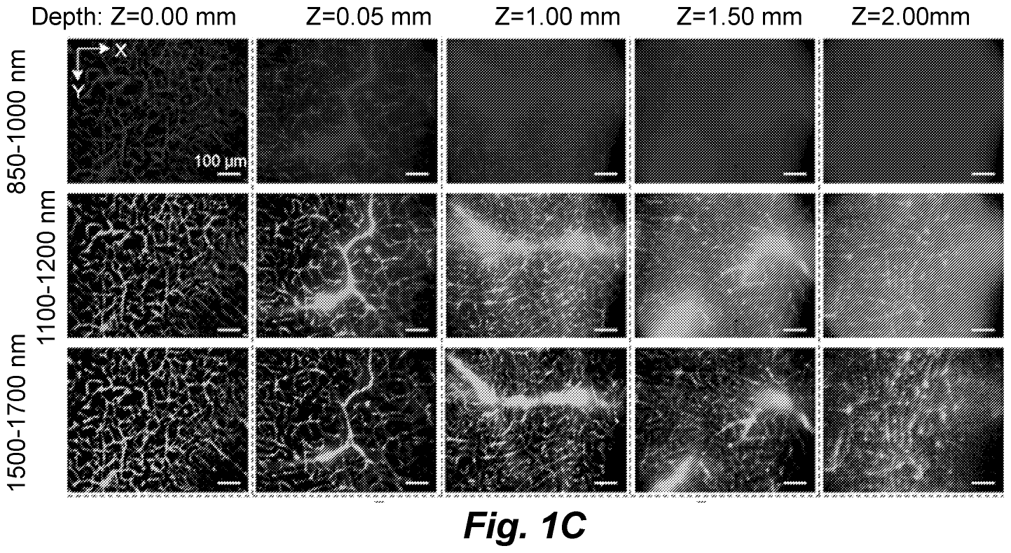

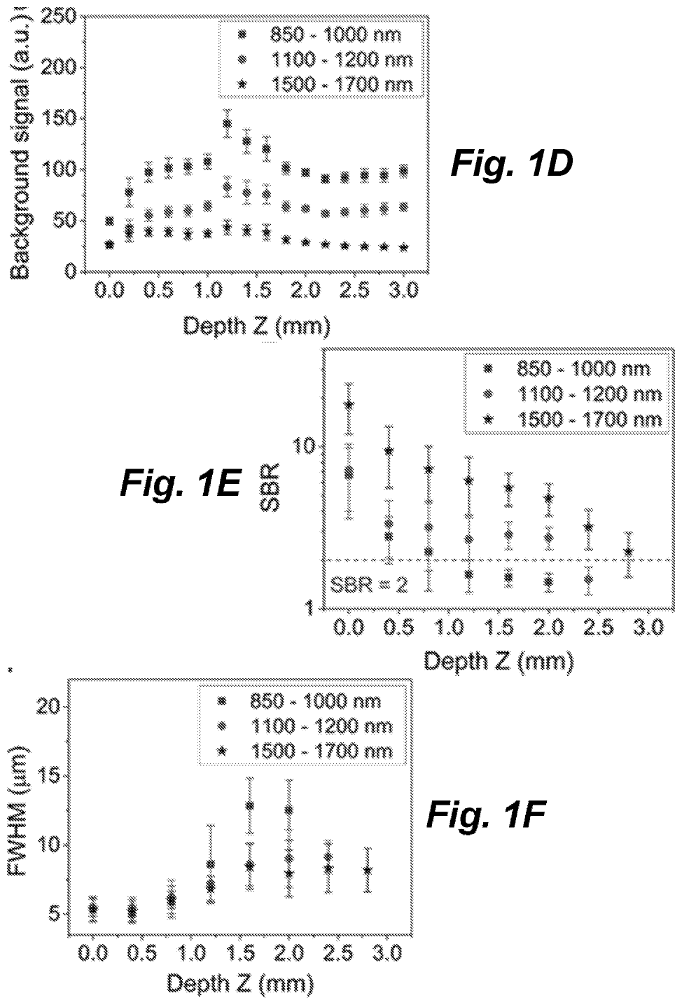

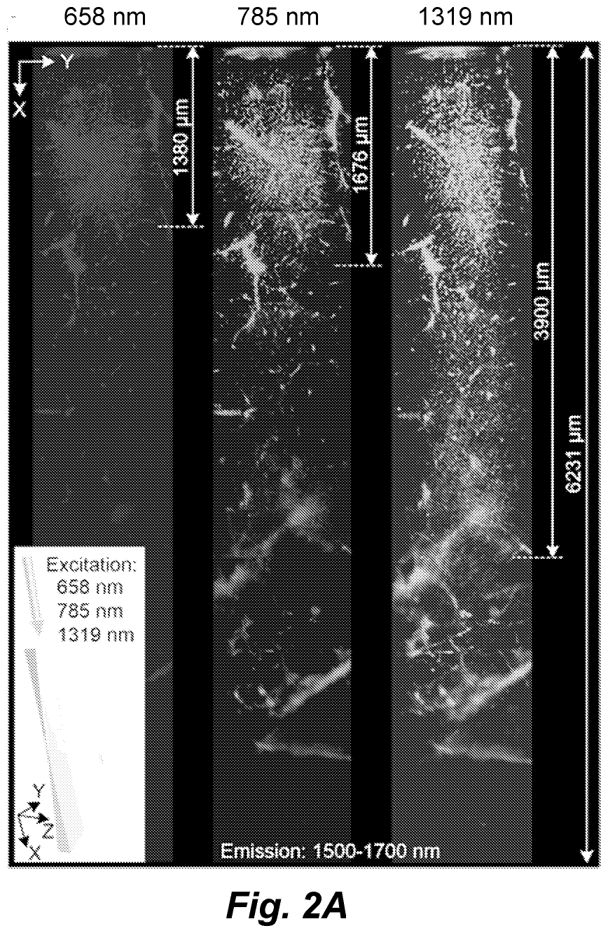

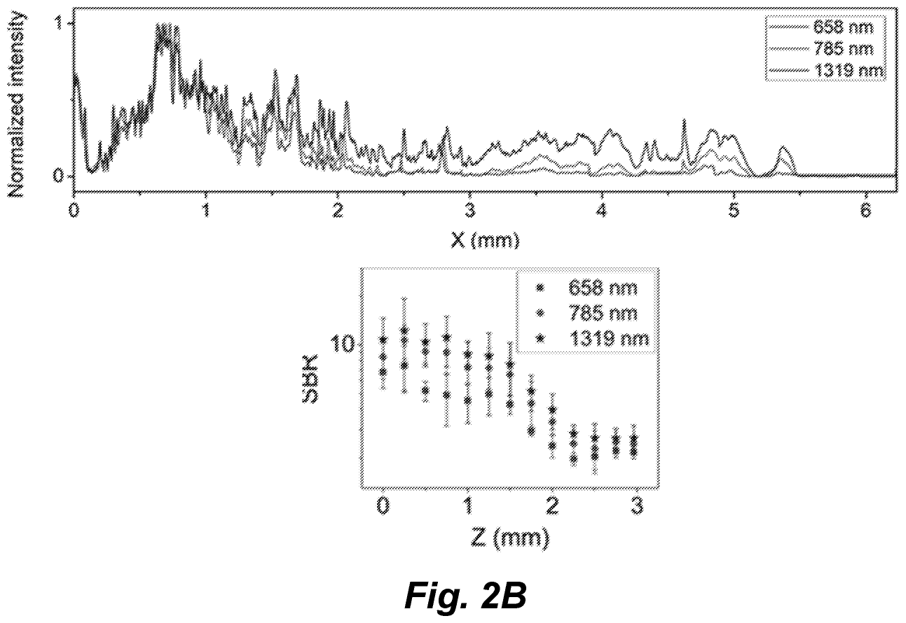

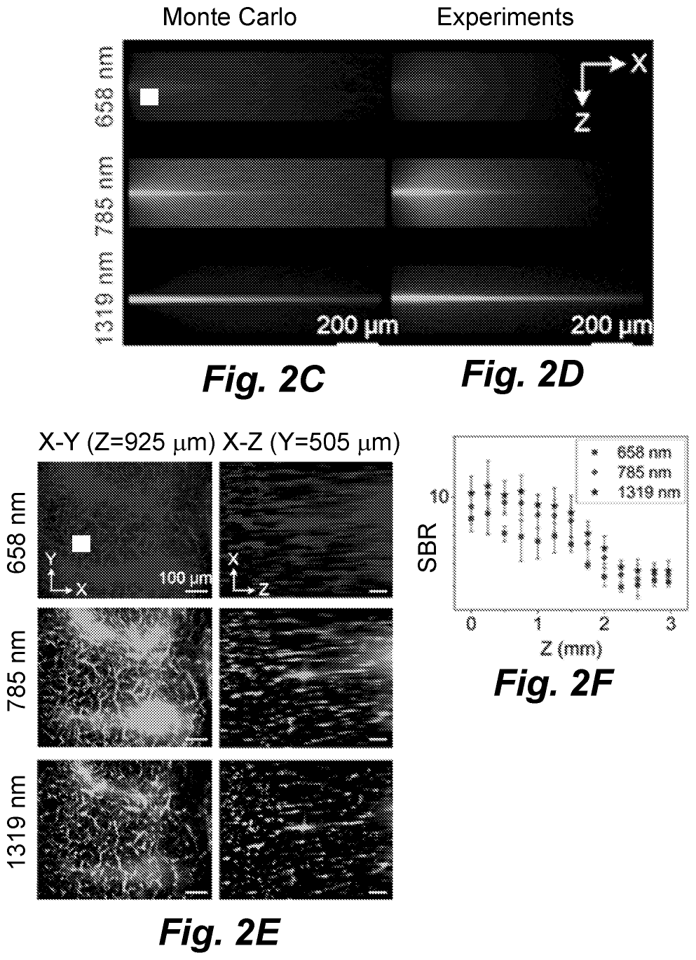

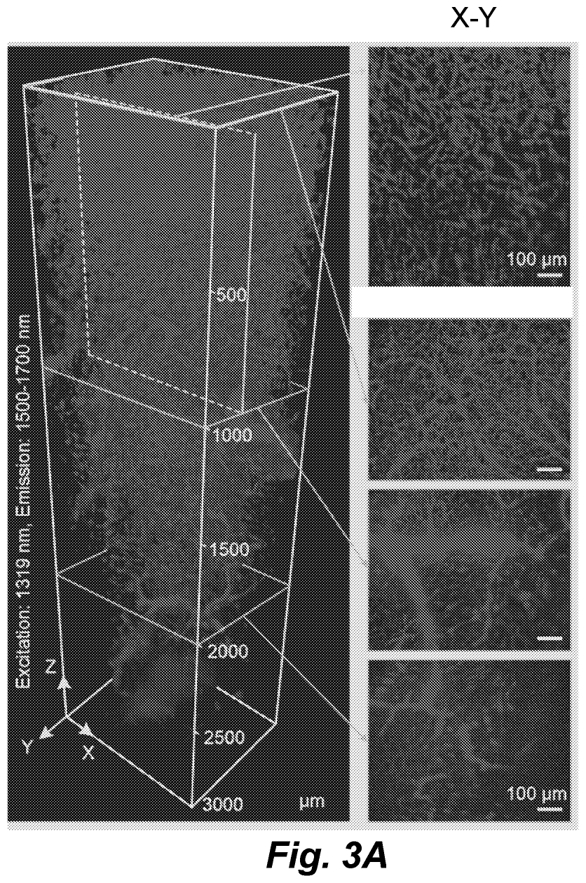

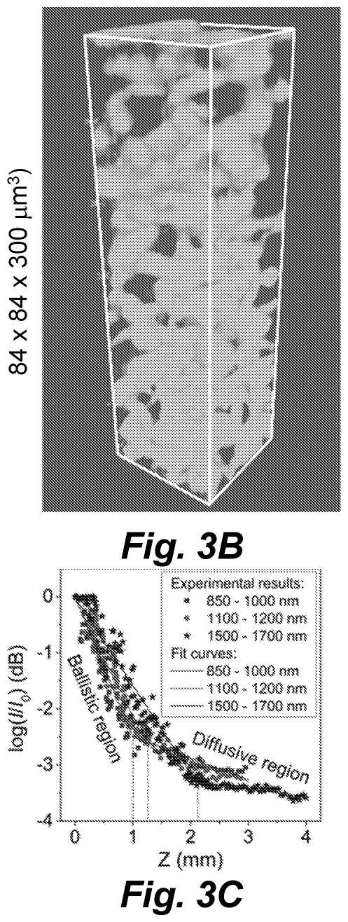

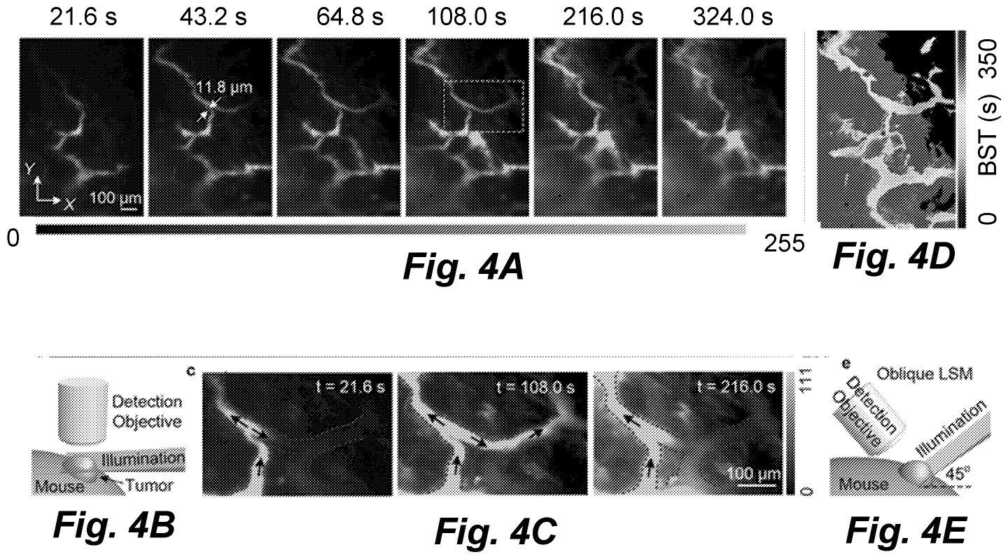

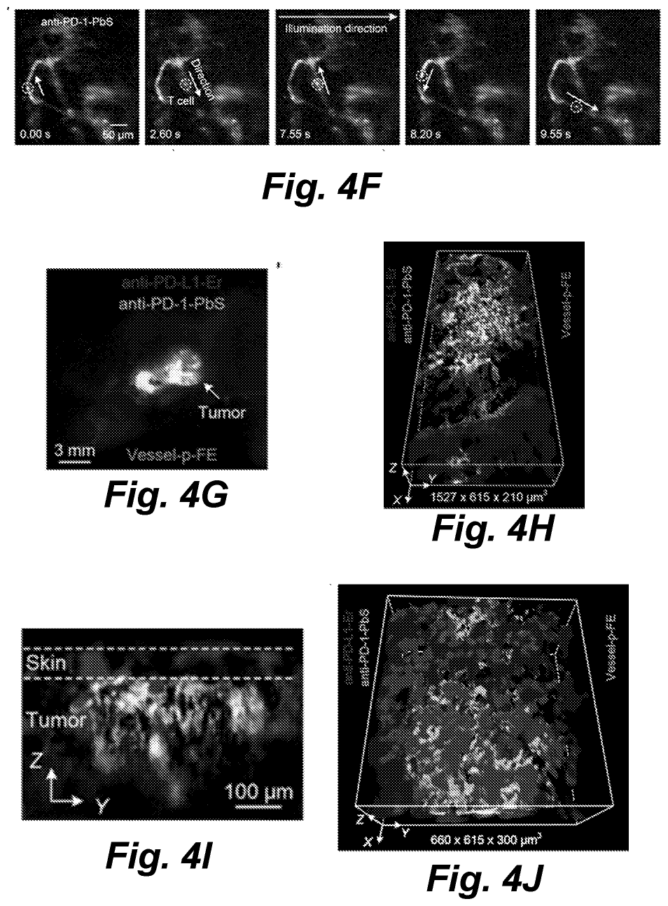

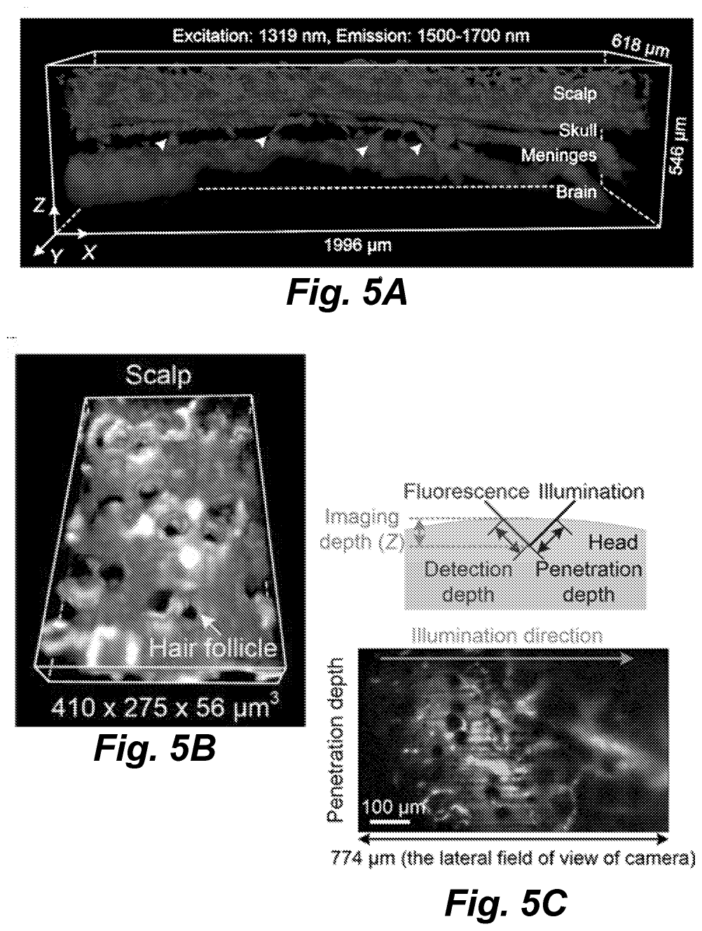

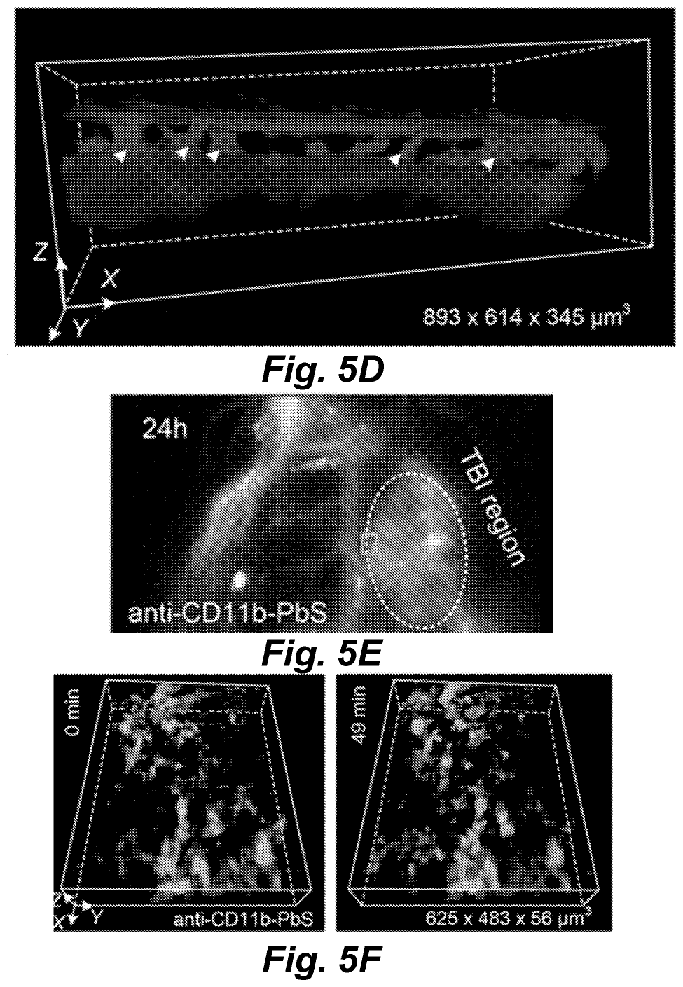

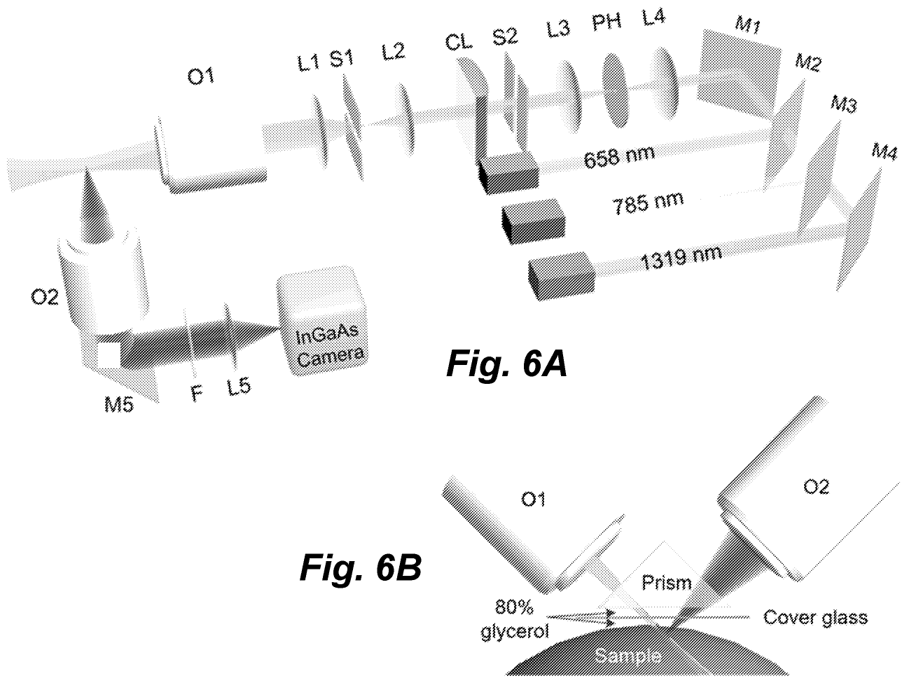

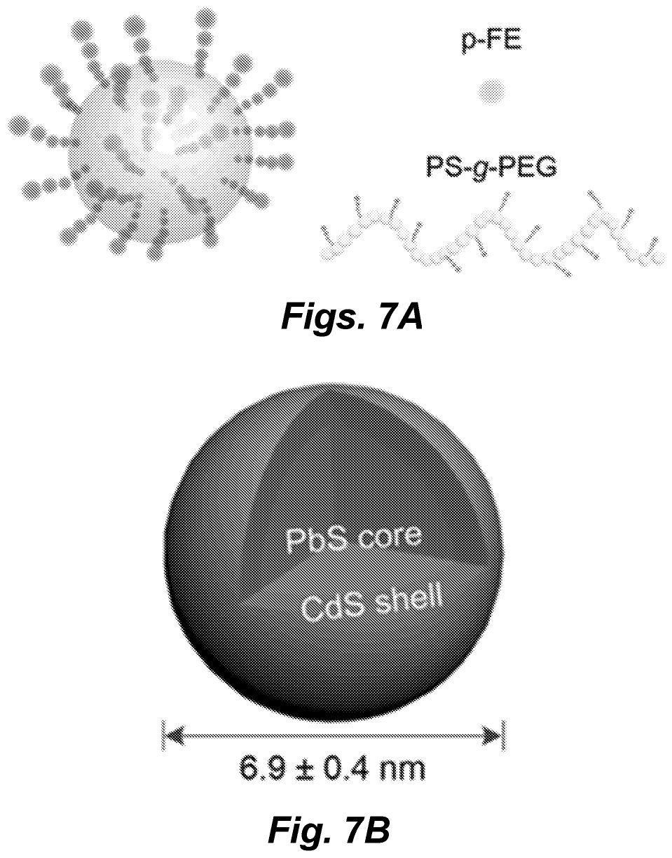

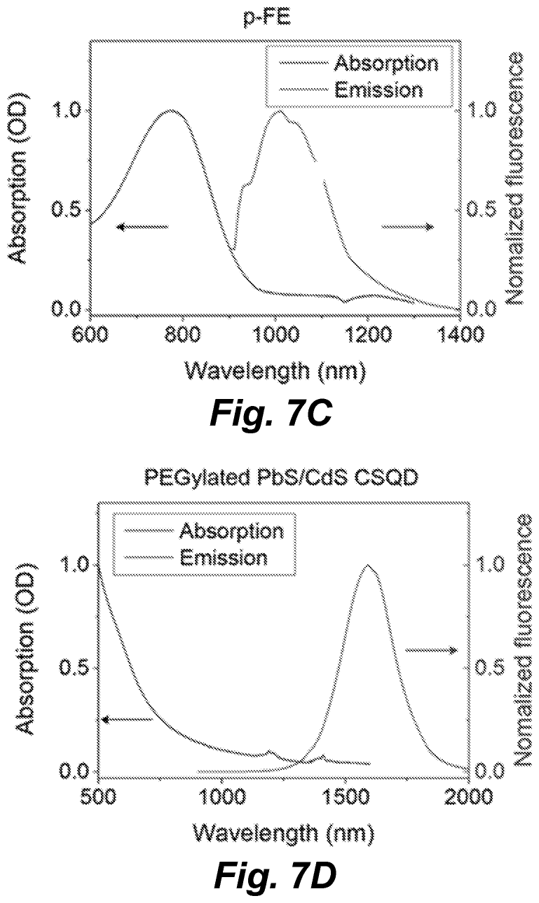

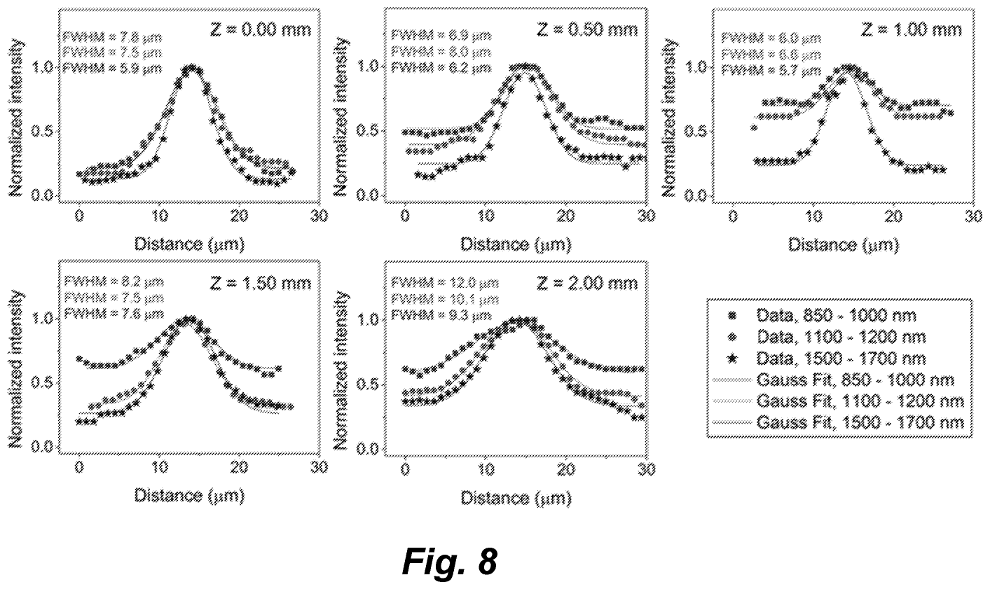

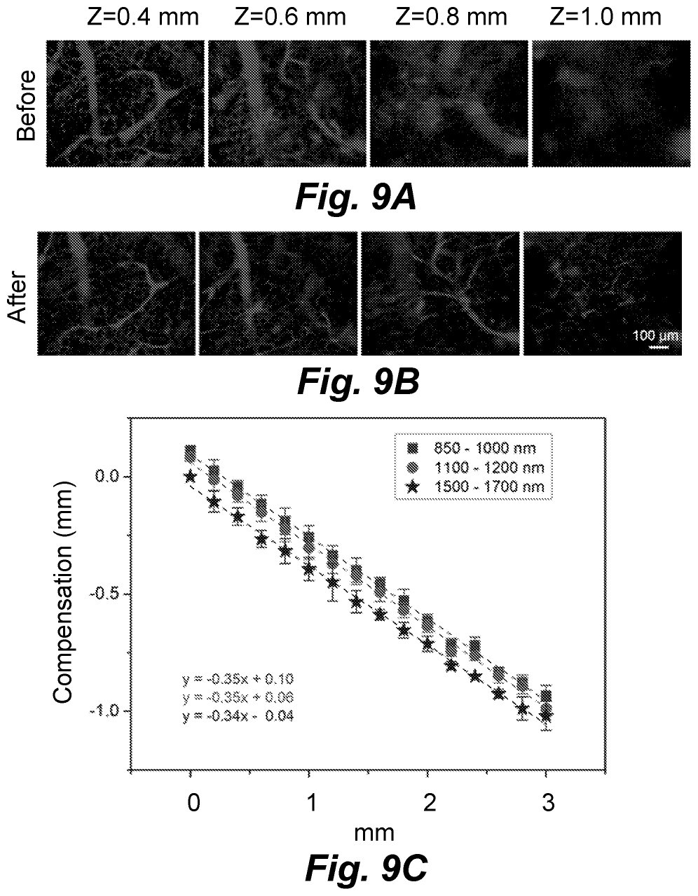

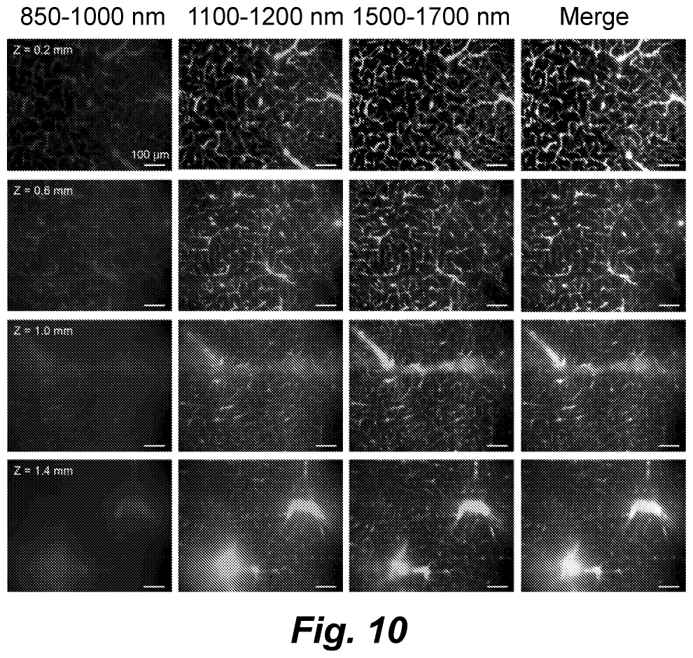

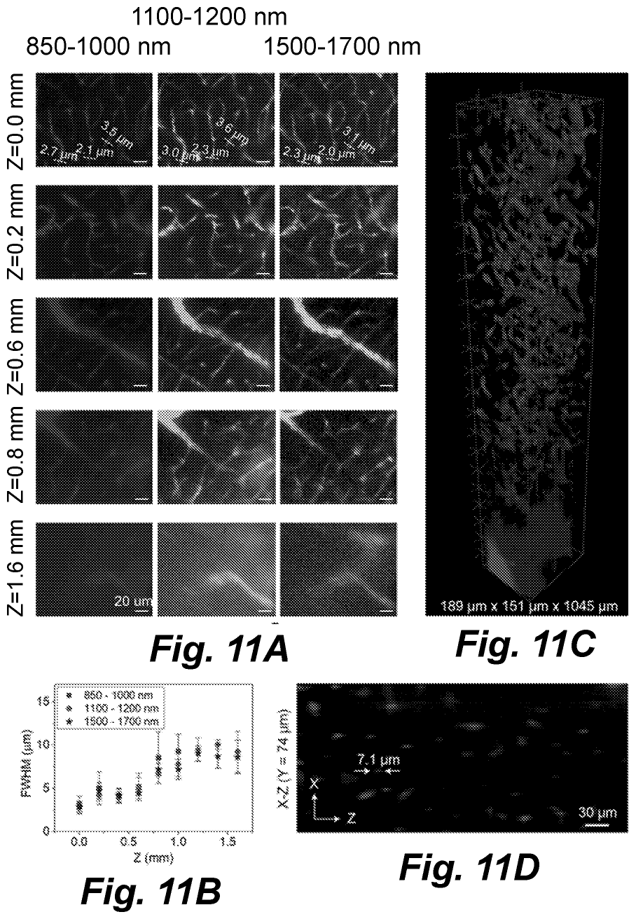

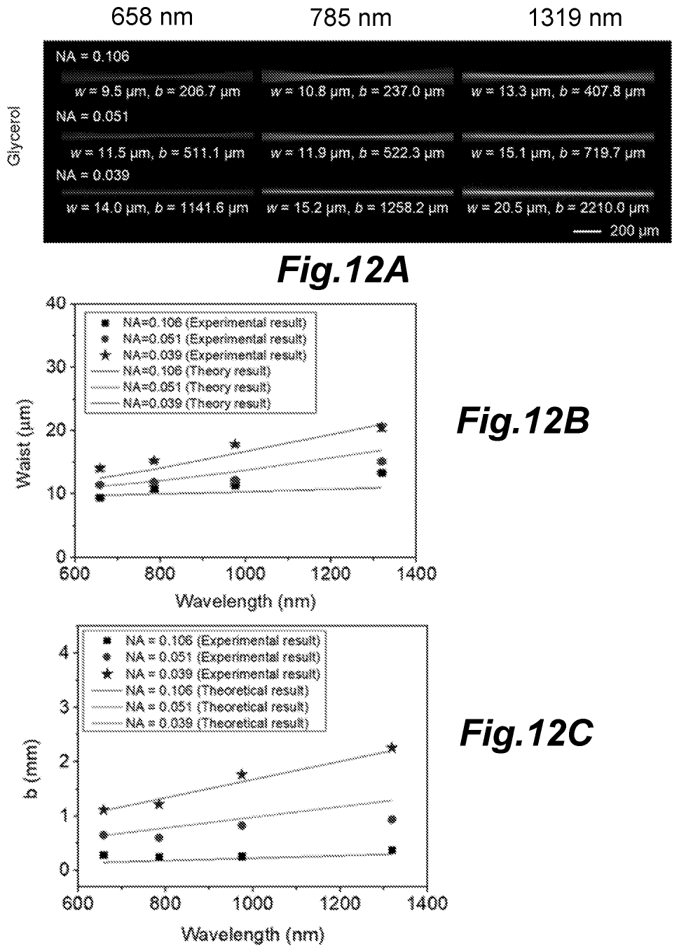

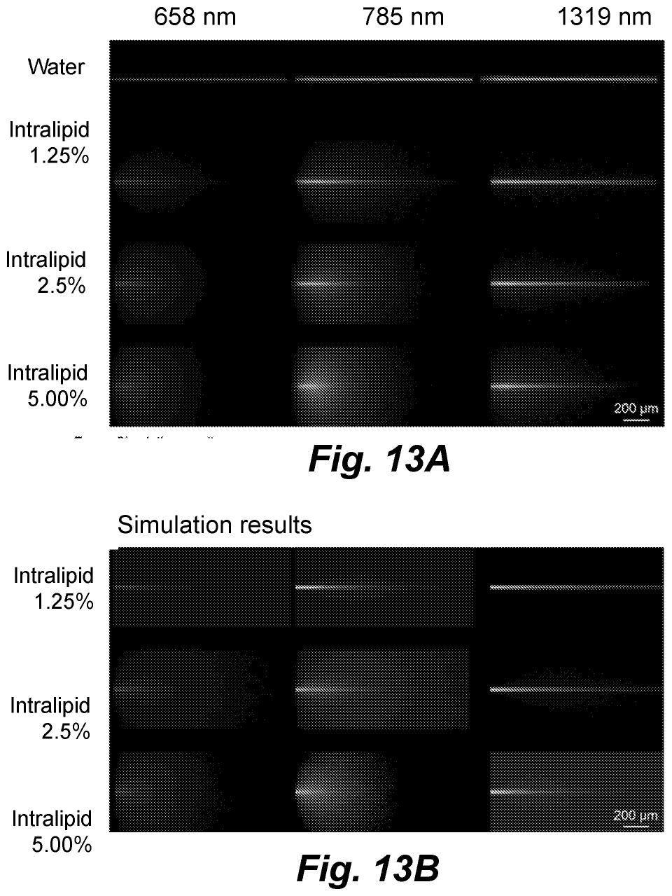

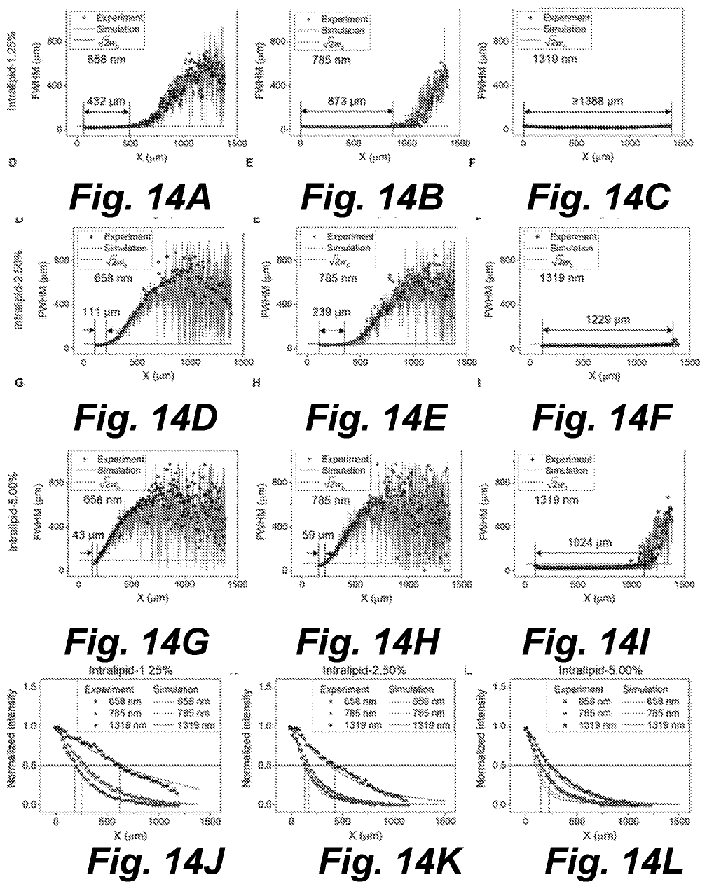

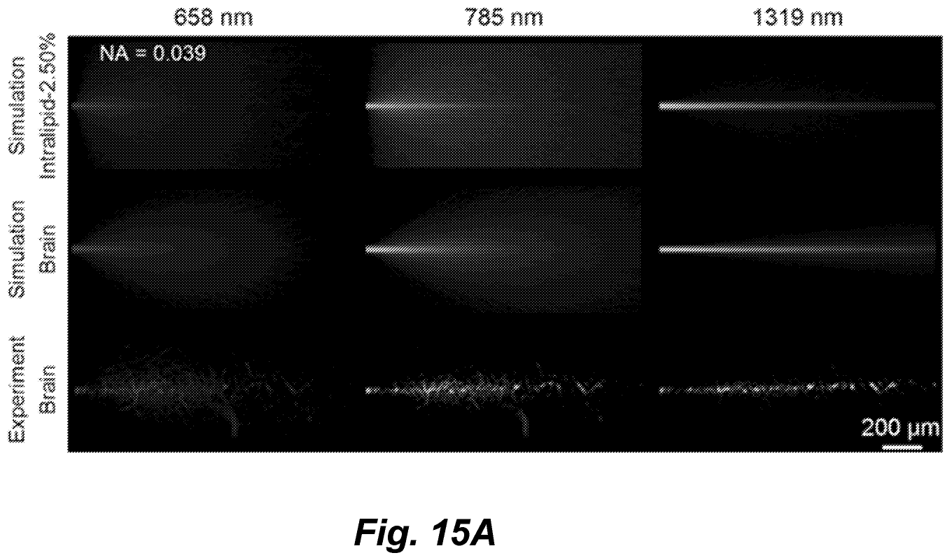

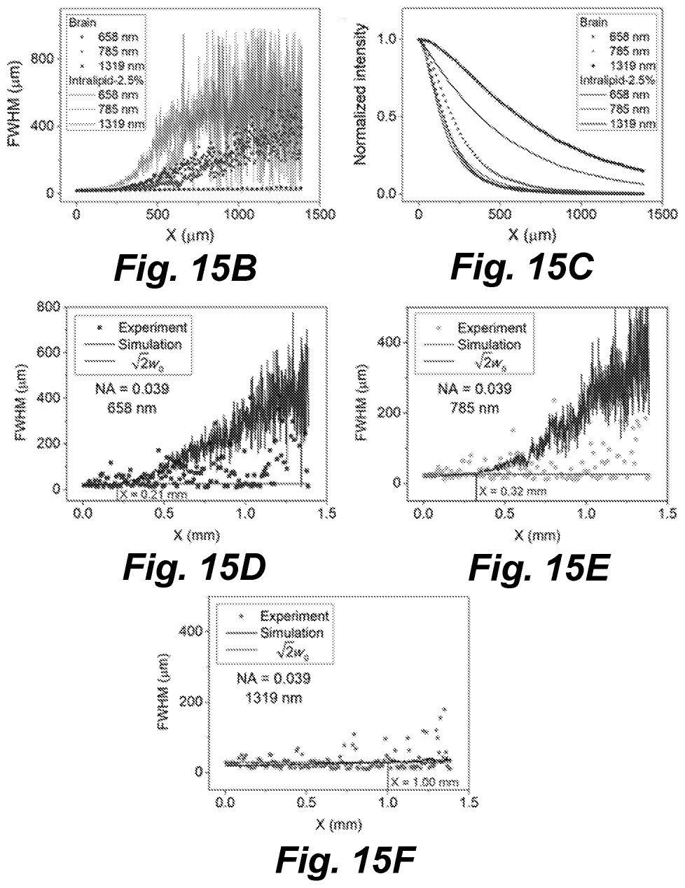

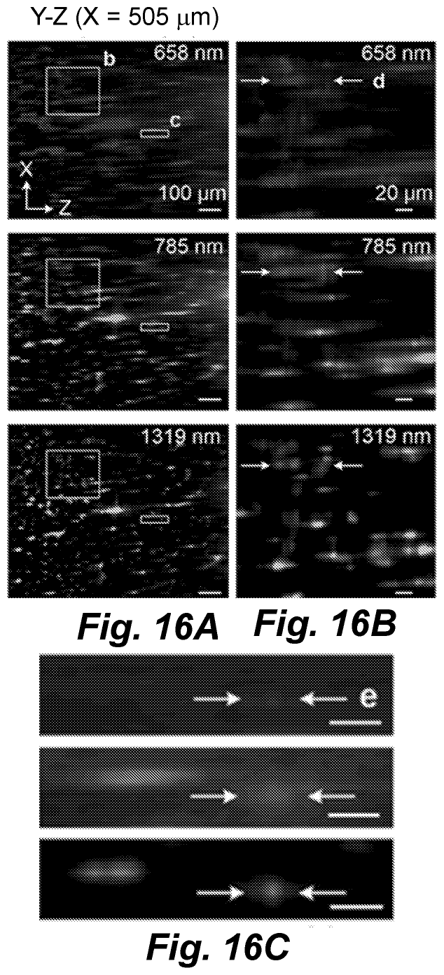

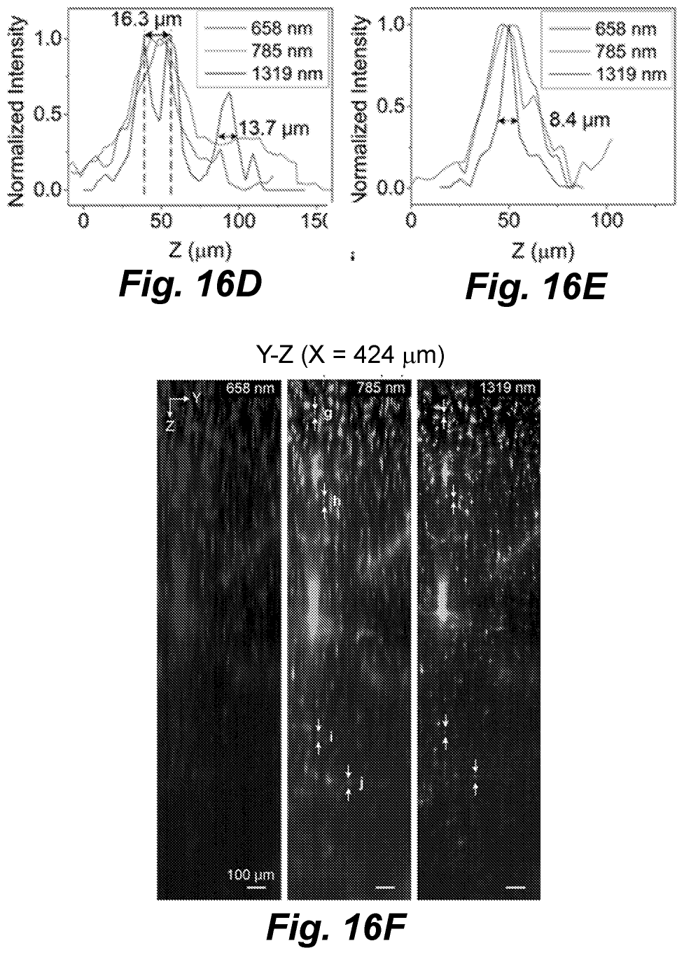

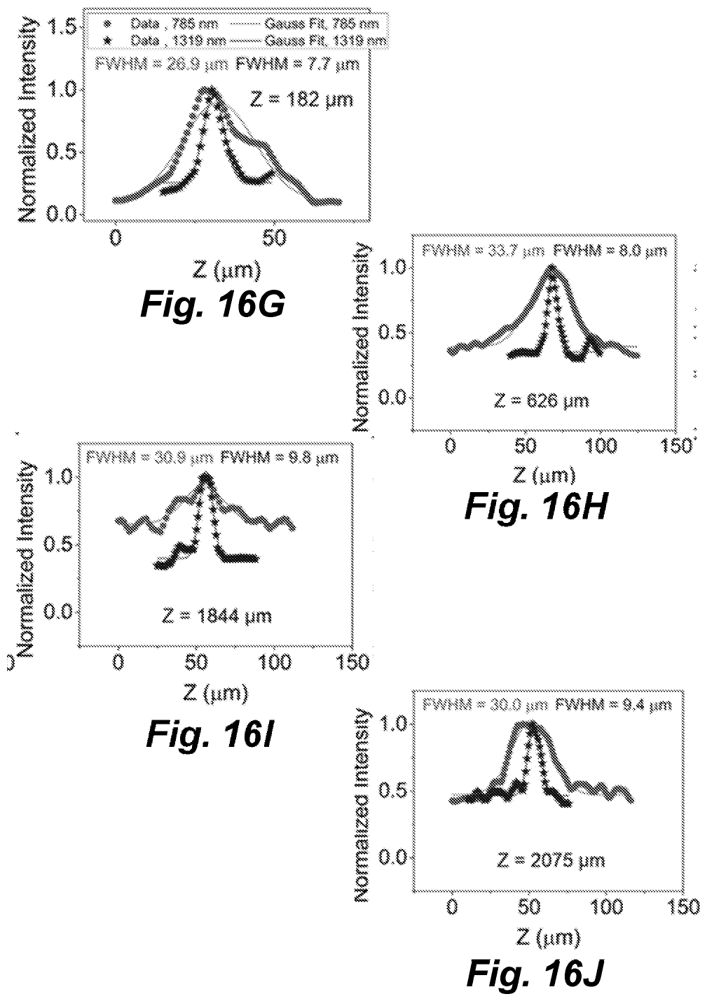

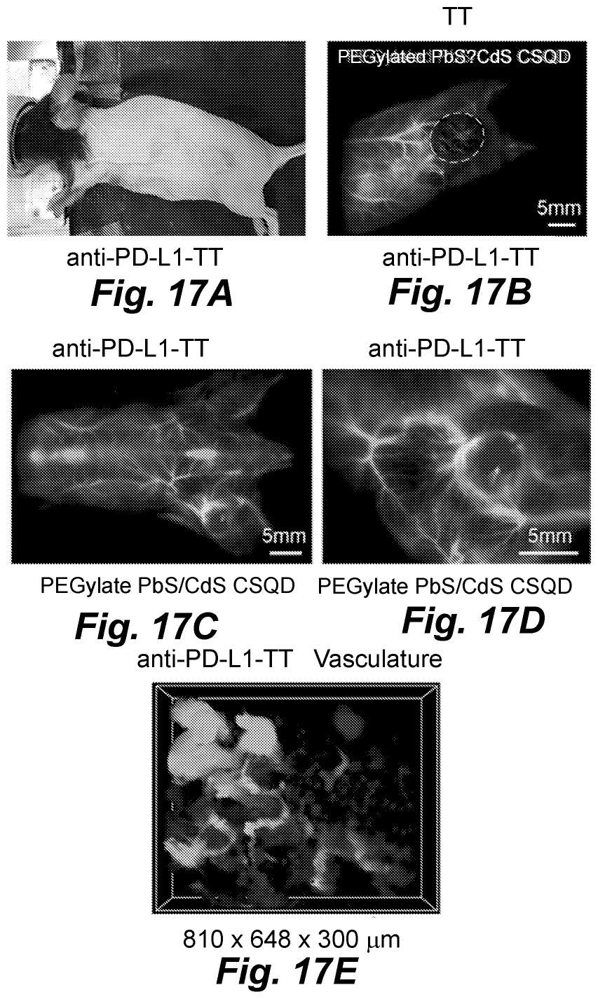

FIGS. 1D-1F illustrate a comparison of (FIG. 1D) background signal, (FIG. 1E) signal-to-background ratio and (FIG. 1F) full width at half maximum (FWHM) of smallest vessels at various depths. Background was measured from randomly selected area without vasculatures. SBR is the ratio of fluorescence signals in randomly selected vasculatures over the background. Error bars were derived from analyzing approximately ten target data at every depth. A 10× (NA=0.25) imaging objective and a 5× illumination objective (effective NA=0.039), light sheet waist w=approximately 15.2 μm, and Rayleigh length b=approximately 1258.2 μm for 785-nm excitation were used.

FIGS. 2A-2F illustrate the propagation of light sheet excitation in brain tissues with progressively longer wavelengths up to 1319 nm.

FIG. 2A illustrates X-Y images of 1500-1700 nm quantum dot fluorescence in the vasculatures of a fixed brain tissue at a depth Z=approximately 200 μm under 658 nm, 785 nm and 1319 nm light sheet illumination as shown in the inset. Six images were taken along X and stitched together for each light sheet.

FIG. 2B illustrates normalized sum intensity along Y direction of images in FIG. 2A as a function of propagation distance (X).

FIGS. 2C and 2D respectively illustrate Monte Carlo simulations and experimental results showing the X-Z propagations of different wavelengths light sheets in 2.5% intralipid tissue phantom (mimicking the brain) containing PEGylated PbS/CdS CSQD (emission: 1500-1700 nm). Scattering coefficient μₛ=109.3 cm⁻¹, 73.5 cm⁻¹ and 20.5 cm⁻¹ and anisotropy g=0.72, 0.64 and 0.34 were used to simulate 658 nm, 785 nm and 1319 nm excitation conditions respectively. Scale bars: 200 μm.

FIG. 2E (Left panels) illustrate X-Y images of quantum dot 1500-1700 nm fluorescence in brain vasculatures taken at Z=925 μm under excitations by (left panels, top-bottom) 658 nm, 785 nm and 1319 nm light sheets respectively.

FIG. 2E (Right panels) illustrate images along the X-Z plane at a fixed Y, reconstructed from X-Y images at various depth Z. A 10×, 0.25-NA detection objective was used and LS excitation was generated by a 5× illumination objective with an effective NA of approximately 0.039 (see Methods for experimental details and FIG. 11 for light sheet shape analysis). Scale bars: 100 μm.

FIG. 2F is a graph illustrating a comparison of SBR for X-Y images recorded at different depth for 658 nm, 785 nm and 1319 nm excitation. About 10 randomly selected vasculatures and 10 areas without vasculatures were analyzed to calculate SBR at each depth.

FIGS. 3A-3C illustrate volumetric 1500-1700 nm fluorescence imaging of mouse brain sectioned by a 1319 nm light sheet.

FIG. 3A illustrates a 3D rendering of PEGylated PbS/CdS CSQD labelled vasculatures in mouse brain. 1500-1700 nm fluorescence was collected at 1319 nm excitation by a 10× detection objective. A 5× illumination objective (with an effective NA=approximately 0.051) was used to generate LS excitation. The scanning increment along Z was 3 μm. The excitation power (approximately 1.4 mW) and the exposure time (0.8 s) were kept constant during entire sectioning. Panel right, first: maximum-intensity Y-projection (50 μm in thickness along Y), the maximum-intensity Y-projection took the brightest pixel in X-Z layers through 50-μm the Y distance and displayed the maximum intensity values in the final 2D X-Z image; Panel right, in descending order, shows maximum-intensity Z-projections for a 150 μm-thick volume along Z at Z=0 μm, 1000 μm and 2000 μm, respectively. Scale bars, 100 μm.

FIG. 3B illustrates a 3D rendering of a smaller region of FIG. 3A.

FIG. 3C illustrates the maximum fluorescence intensity (I) in different emission regions detected at various depths (Z) in the mouse brain. I₀ is the fluorescence intensity at Z=0 μm. In these experiments, the brain was taken out from a mouse intravenously injected with p-FE (excitation: 785 nm, emission: 850-1000 nm and 1100-1200 nm) and PEGylated PbS/CdS CSQD (excitation: 785, emission: 1500-1700 nm) with 5-min interval at 30 min post injection. Then the mouse brain was fixed and preserved in glycerol for ex vivo imaging.

FIGS. 4A-4J illustrate non-invasive in vivo NIR-II light sheet microscopy of tumors on mice.

FIG. 4A illustrates a time-course LSM of tumor vasculatures imaged by NIR-II LSM shown in FIG. 4B at a fixed illumination plane below the top of a xenograft MC38 tumor on mouse ear at Z approximately 300 μm after intravenous injection of p-FE (excitation: 785 nm, emission: 1000-1200 nm).

FIG. 4B illustrates a 4× detection objective and a 5× illumination objective in a normal, non-oblique configuration as used to generate the images shown in FIG. 4A.

FIG. 4C illustrates abnormal blood flows in tumor vessels imaged by NIR-II LSM shown in FIG. 4B, showing on-off intermittency and direction reversal in the rectangular highlighted region in FIG. 4A and gradual extravasation into tumor space. Similar results were obtained for n=3 (C57BL/6, female, 6 weeks old). Black arrows represent flow direction.

FIG. 4D illustrates a BST map showing highly heterogeneous blood perfusion in tumor vessels and slow, inhomogeneous extravasation behavior into tumor space (C57BL/6, female, 6 weeks old; similar results for n=2).

FIG. 4E is a schematic illustration of in vivo oblique NIR-II LSM with illumination and detection at 45° to mouse body (as shown in FIG. 6B).

FIG. 4F illustrates a time-course obtained using oblique NIR-II LSM shown in FIG. 4E of PD-1+ cells (white circles) in a CT26 tumor labeled by anti-PD-1-CSQDs 2 h after intravenous injection of anti-PD-1-CSQDs at 20 fps by oblique LSM.

FIG. 4G illustrates wide-field imaging obtained using oblique NIR-II LSM shown in FIG. 4E of anti-PD-L1-Er, anti-PD-1-PEGylated PbS/CdS CSQD labeled cells, and p-FE filling vessels in a CT26 tumor.

FIG. 4H illustrates non-invasive in vivo three-plex 3D light sheet microscopy obtained using oblique NIR-II LSM shown in FIG. 4E of anti-PD-L1-Er, anti-PD-1-PEGylated PbS/CdS CSQD and vasculatures (p-FE), which is approximately 120 μm beneath the surface in a CT26 tumor.

FIG. 4I illustrates an Y-Z cross section of the tumor shown in FIG. 4G obtained using oblique NIR-II LSM shown in FIG. 4E.

FIG. 4J illustrates a local zoom three-plex 3D LSM obtained using oblique NIR-II LSM shown in FIG. 4E of the tumor shown in FIG. 4G.

FIGS. 5A-5F illustrate non-invasive in vivo light sheet imaging of mouse head by oblique NIR-II LSM.

FIG. 5A illustrates a 3D reconstructed image of blood vessels in an intact mouse through the scalp, skull, meninges and brain cortex obtained 2 h after intravenous injection of PEGylated PbS/CdS CSQD by an oblique NIR-II LSM shown in FIG. 3E. The white triangles point to the vascular channels connecting the brain cortex and skull in the meninges.

FIG. 5B illustrates a zoomed-in 3D view of the scalp layer showing follicle structures.

FIG. 5C illustrates: (top) a schematic diagram showing the definitions of penetration depth, detection depth and imaging depth in oblique NIR-II LSM. The illumination direction was about 45° to mouse head; (bottom) an original image recording a cross section along the illumination direction in FIG. 5A crossing the full field of field (FOV) of camera when a 10× imaging objective was used. In FIGS. 5A-5C, similar imaging was performed at three positions of the heads of two mice (BALB/c, female, 4 weeks old), for a total n=6.

FIG. 5D illustrates a 3D reconstructed image of vascular channels (triangles marks) in the meninges obtained at a later time point 12 h after injection of PEGylated PbS/CdS CSQD with 4-μm scan increment along X axis and 10-ms exposure (BALB/c, female, 4 weeks old; similar results for n=2).

FIG. 5E illustrates wide-field traumatic brain injury (TBI) imaging of mouse head 26 h after injury and 24 h after intravenous injection of anti-CD11b-PEGylated PbS/CdS CSQD.

FIG. 5F illustrates 3D time-course light sheet imaging/monitoring of meningeal macrophages/microglia dynamics following brain injury 24 h after injection of anti-CD11b-PEGylated PbS/CdS CSQD at the boundary of TBI region (rectangular marked area in FIG. 5E). CD11b+ macrophages/microglia labeled recruited to the injury was monitored (BALB/c, female, 4 weeks old; similar results for n=2).

FIG. 6A illustrates a schematic of the Light Sheet Microscope (LSM) in the second near infrared window. The components are as follows: illumination objective (O1), achromatic lenses (L1-L5), adjustable mechanical slits (S1, S2), cylindrical lens (CL), pinhole (PH), mirrors (M1-M5), detection objective (02) and emission filters (F). Three excitation lines can be selected by removable mirrors (M2-M4). A spatial filter was introduced to improve the circularity and quality of the illumination beam and to generate uniform light sheet across the field of view. Before the laser entering a cylindrical lens (CL), a vertically arranged adjustable mechanical slit S2 parallel to the CL was used to adjust the span range of light sheet along Y-axis direction. After magnified by a pair of achromatic lenses (L1, L2), the incident light was focused on the back focal plane of illumination objective (01). For LSM, the actual illumination NA was adjusted by S1 and the span range along Y was controlled by S2. Fluorescence was collected through a detection objective (02) and a 200-mm tube lens, then transmitted to a liquid-nitrogen-cooled InGaAs camera (2D-OMA V, Princeton Instruments) after filtered by selected emission filters. The focal lengths of L1, L2, L3, L4 were 60 mm, 100 mm, 30 mm and 60 mm, respectively. A 4× objective (NA=0.1, Bausch & Lomb Optical Co.), a 5× objective (NA=0.15, Nikon LU Plan), a 10× objective (NA=0.25, Bausch & Lomb Optical Co.) and a 50× objective (NA=0.6, Nikon CF Plan) were used in the experiments.

FIG. 6B illustrates a schematic oblique LSM with the same optical path as the normal LSM shown in FIG. 6A but the illumination objective and detection objective was arranged 45° to horizontal direction. In this configuration, an UV fused silica right-angle prism was used. A cover glass and samples were fixed on scanning stage. The gaps between the prism, cover glass and sample were filled with 80% glycerol to compensate for refractive index mismatch. A 4× objective (NA=0.1, Bausch & Lomb Optical Co.), a 5× objective (NA=0.15, Nikon LU Plan), a 10× objective (NA=0.25, Bausch & Lomb Optical Co.) and a 50× objective (NA=0.6, Nikon CF Plan) were selectively used in these experiments

FIGS. 7A-7D illustrate an organic nanofluorophore p-FE dye and PEGylated PbS/CdS CSQD (core-shell quantum dot) probe.

FIG. 7A illustrates a schematic of p-FE comprised of organic dyes trapped in amphiphilic polymeric micelles approximately 12 nm in size measured by dynamic light scattering (Zhang et al., Proc. Natl. Acad. Sci. USA 115: 6590-6595 (2018)).

FIG. 7B illustrates a schematic of PEGylated PbS/CdS CSQD with a wide range of excitation wavelength spanning from UV to approximately 1300 nm, high brightness, biocompatibility and liver excretion developed recently (Keller et al., Nat. Methods 7: 637-655 (2010)).

FIG. 7C illustrates absorption and emission spectra of p-FE.

FIG. 7D illustrates absorption and emission spectra of PEGylated PbS/CdS CSQD.

FIGS. 8A and 8B illustrate light sheet microscopy in various NIR 850-1700 nm emission sub-regions in glycerol-cleared brain tissues.

FIG. 8A illustrates light-sheet optical sectioning mouse brain vasculatures at various depths in NIR-1, NIR-IIa and NIR-IIb emission regions using the same 785 nm light sheet illumination kept constant power (0.33 mW) at different depths. The glycerol-cleared mouse brain tissue sample was prepared by intravenous injection of p-FE (emission: 850-1000 nm and 1100-1200 nm) and PEGylated PbS/CdS CSQD (emission: 1500-1700 nm) at 5-min interval. The mouse was scarified 30 min post injection of the probes while still in circulation. The mouse brain was taken out, fixed and preserved in glycerol for ex vivo imaging. Similar results for n=3 independent experiments (C57BL/6, female, 6 weeks old).

FIG. 8B illustrates cross-sectional normalized fluorescence intensity profiles (scatters) and Gaussian fit (solid lines) along the white-dashed bars in FIG. 8A at different imaging depth (Z) in different collection windows. Similar results for n=3 independent experiments (C57BL/6, female, 6 weeks old).

FIGS. 9A-9C illustrate the compensation of refractive index mismatch for NIR LSM imaging. As the imaging depth changes, an obvious misalignment of light sheet and the working plane of imaging objective appeared resulting from refractive index mismatch between the tissue and surrounding air and was compensated by a linear movement of detection objective.

FIGS. 9A and 9B illustrate light sheet (LS) imaging of vasculatures (FIG. 9A) before and (FIG. 9B) after objective compensation in glycerol-cleared mouse brain at different depths. Fluorescence signal of PEGylated PbS/CdS CSQD in vasculatures was collected in 1500-1700 nm range under an excitation of 1319 nm. n=3 independent experiments (C57BL/6, female, 6 weeks old).

FIG. 9C illustrates the compensation movement of detection objective at each depth Z determined for 850-1000 nm, 1100-1200 nm and 1500-1700 nm fluorescence imaging under the same 785 nm excitation.

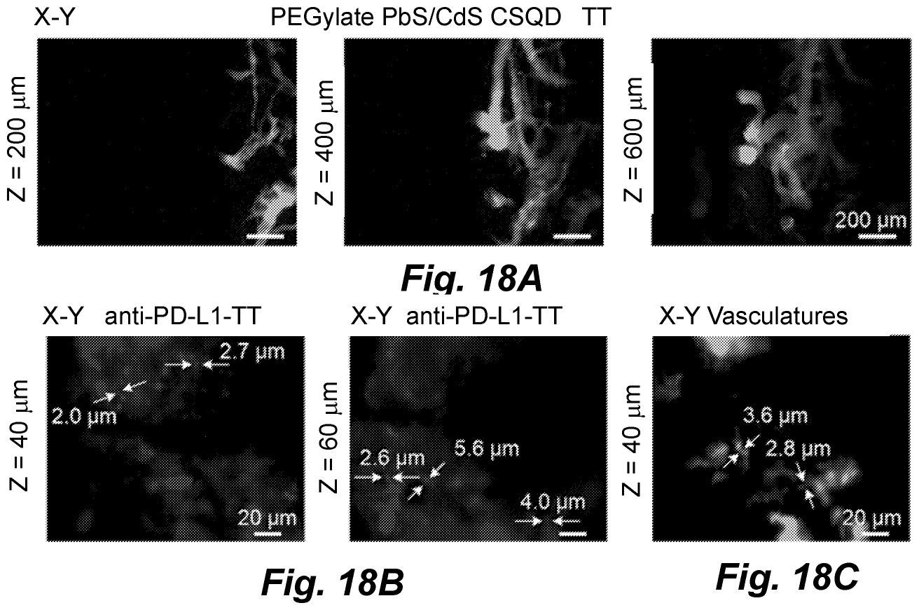

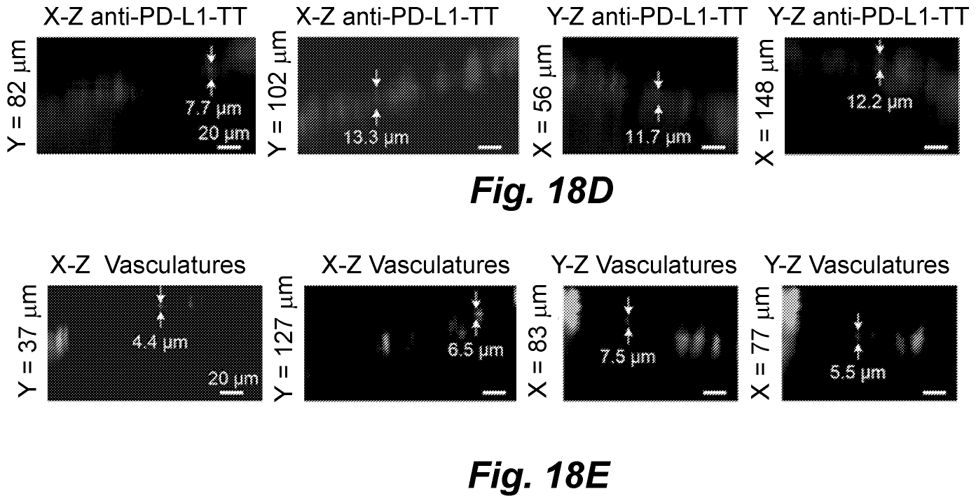

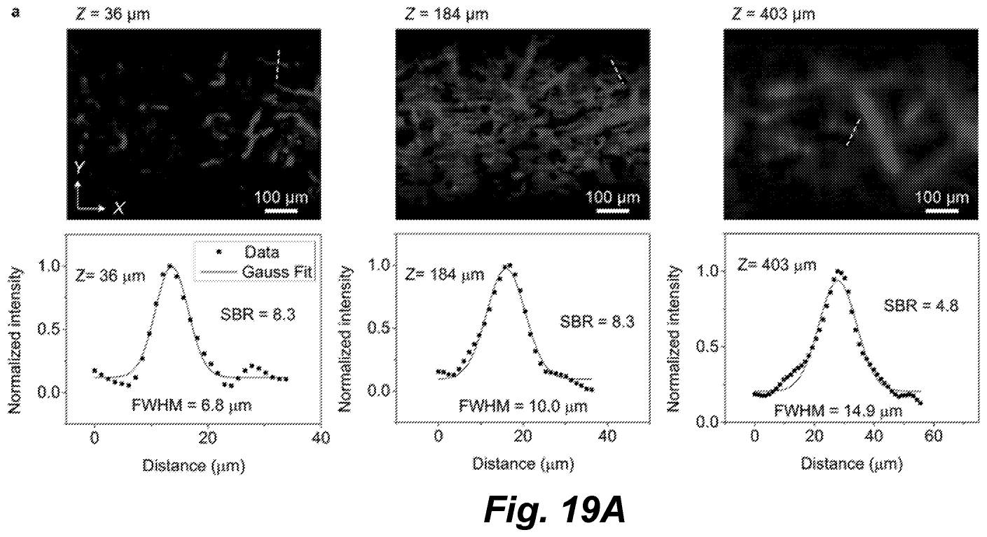

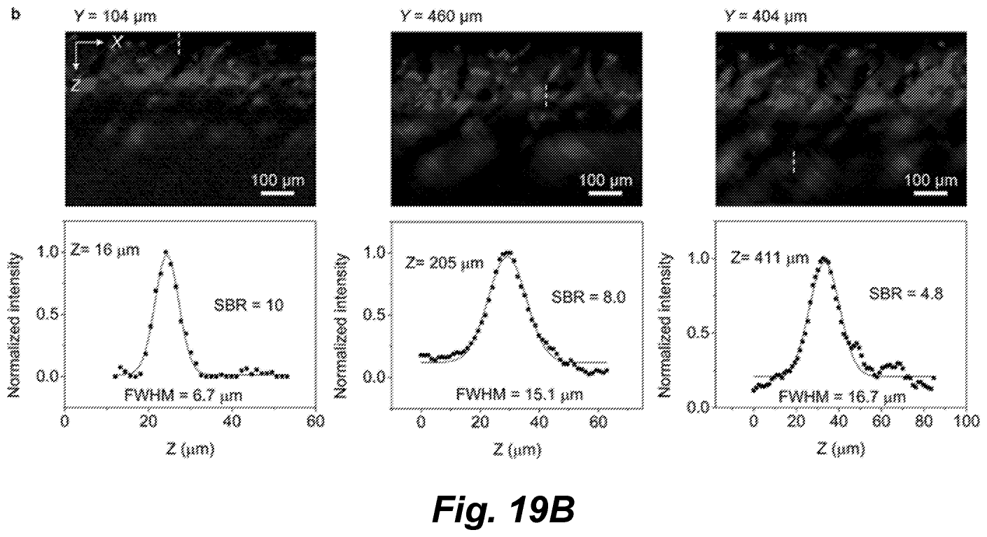

FIG. 10 illustrates overlaying different fluorescence emission channels with objective compensation for NIR LSM. Three-channel brain vasculature images were recorded by scanning over the same volume of a mouse brain tissue sample three times during which fluorescence signal in 850-1000 nm (p-FE), 1100-1200 nm (p-FE) or 1500-1700 nm (PEGylated PbS/CdS CSQD) was recorded under the same 785 nm LS illumination. A 10× detection objective and a 5× illumination objective were used. The overlay images at various depths show accurate alignment of the scanning positions during successive volumetric imaging. To prepare the brain sample, p-FE and PEGylated PbS/CdS CSQD were sequentially injected intravenously into a mouse at an interval of 5 min, sacrificed the mouse at 30 min post injection, fixed the brain and preserved it in glycerol for ex vivo LSM imaging. Scale bars, 100 μm.

FIGS. 11A-11D illustrate high resolution 3D imaging of vasculatures in mouse brain.

FIG. 11A illustrates images of fluorescence signal collected in three different spectral windows excited by the same 785 nm laser. A 50× (NA=0.6) imaging objective was used.

FIG. 11B illustrates full width at half maximum (FWHM) measurements of smallest blood vessels at different depths seen using a 50× (NA=0.6) imaging objective and a 10× (NA=0.25) illumination objective. The measurement of FWHM at different depths shows that the smallest vasculatures imaged are in the 2.5-10 μm range, increasing at deeper depth. The resolution is sufficient for imaging single cells up to approximately 2 mm brain depth.

FIG. 11C illustrates a 3D rendering of p-FE labelled vasculatures in mouse brain excited by a 785-nm laser and collected in 1100-1200-nm window. The scanning Z incensement was 1 μm. A 50× (NA=0.6) imaging objective and a 10× (NA=0.25) illumination objective were used.

FIG. 11D illustrates selected X-Z cross section of the 3D rendering of FIG. 11C.

FIGS. 12A-12C illustrate imaging of 658 nm, 785 nm and 1319 nm light sheet propagation in glycerol to glean light sheet shape.

FIG. 12A illustrates light sheets formed by three values of NA imaged in glycerol containing uniformly suspended PEGylated PbS/CdS CSQD. The emission was collected in 1500-1700-nm window. w is the waist and b is the double Rayleigh range of light sheet. The cylindrical lens was rotated by 90° and used mechanical slits to control the actual NA and the spanning range along Y as shown in FIG. 1A. The illumination plane was also rotated by 90° and the light sheet shape recorded in a side view. The light sheet was generated by a 5× illumination objective and seen using a 4× detection objective.

FIGS. 12B and 12C illustrate comparisons of experimentally measured light sheet characteristics and theoretically estimated results considering the influence from the performance of the real imaging system, i.e., the convolution of theoretical estimation (w=2λ/πNA and b=2πw²/λ) and the point spread function (estimated by Rayleigh criteria, 0.61λ/NA).

FIGS. 13A and 13B illustrate light sheet propagation in water and scattering intralipid solutions with different intralipid concentrations.

FIG. 13A illustrates results showing 658 nm, 785 nm and 1319 nm light sheets in water, 1.25% intralipid, 2.5% intralipid and 5.0% intralipid containing PEGylated PbS/CdS CSQD. The LS illumination was rotated by the way as described for FIGS. 11A-11C. A 5× illumination objective with actual NA=0.039 and a 4× detection objective were used. The fluorescence signal was collected in 1500-1700 nm window. Light sheet of each wavelength was firstly seen in water containing PEGylated PbS/CdS CSQD. Then water was replaced by intralipid solutions with different concentrations under the same experimental conditions.

FIG. 13B illustrates Monte Carlo simulations (Power & Huisken Nat. Methods 14: 360-373 (2017)) of light sheets under the experimental conditions shown in FIG. 13A. The illumination waist measured in water was entered as initial FWHM of incident light in Monte Carlo simulations. These simulated results were consistent with the experimental observations and demonstrated that optical scattering plays a dominant role for light sheet microscopy in a scattering tissue.

FIGS. 14A-14L illustrate a comparison of experimentally measured and Monte Carlo simulated light-sheet FWHM and intensity decay along the incident direction in three intralipid solutions.

FIGS. 14A-14I illustrate FWHM from experiment shown in FIG. 13A and the simulation in FIG. 13B by Monte Carlo method. FIGS. 14A-14C: 1.25% intralipid solution; FIGS. 14D-14F, 2.5% intralipid solution; FIGS. 14G-14I, 5% intralipid solution. w₀ is the light-sheet waist at initial incident position. Generally, the length over which the light sheet transmits by less than 1.414 times the initial waist (w₀) is regarded as the distance useful for imaging. FIGS. 14A-14I show the critical length of the 1319-nm excitation was larger than 1000 μm in 1.25%, 2.5% and 5.0% intralipid solutions, much larger than that of 658 nm and 785 nm cases.

FIGS. 14J-14L illustrate normalized intensity with: FIG. 14J, 1.25% intralipid solution; FIG. 14K, 2.5% intralipid solution; and FIG. 14L, 5% intralipid solution. FIGS. 14J-14L illustrate that as the intralipid concentration increased, the intensity along propagation direction attenuated faster but the 1319-nm excitation decayed the slowest compared to 658-nm and 785-nm excitations.

FIGS. 15A-15F illustrate a comparison of light sheet propagating in 2.5% intralipid and mouse brain.

FIG. 15A illustrates MONTE Carlo simulation of light sheets of different wavelength (658 nm, 785 nm and 1319 nm) propagating in: (top) 2.5% intralipid; (middle) brain; a light sheet in mouse brain with vasculatures labelled by PEGylated PbS/CdS CSQD (emission: 1500-1700 nm). The cylindrical lens in the illumination arm was rotated by 90° and a mechanical slit (FIG. 6A) was used to control the actual NA=0.039 as described in FIG. 12A. A 4× detection objective and a 5× illumination objective were used.

FIG. 15B illustrates simulated FWHM of a light sheet along the propagation direction when light sheet incidents into 2.5% intralipid and brain. As the brain tissue exhibited larger anisotropy than intralipid, light sheet transmitted longer in the brain than in intralipid.

FIG. 15C illustrates intensity decaying of light sheet along the propagation direction when light sheet incidents into 2.5% intralipid and brain. As the brain tissue exhibited larger anisotropy than intralipid, light sheet transmitted longer in the brain than in intralipid.

FIGS. 15D-15F illustrate comparisons of experimental data in FIG. 15A (bottom) and simulated data of FIG. 15A (middle) of light-sheet FWHM in mouse brain. w₀ is the light-sheet waist at initial incident position. The incident photons deviate from initial direction due to scattering and it is more serious for illumination with shorter wavelength. The simulated light propagation in brain was consistent with experimental results of 658 nm, 785 nm and 1319 nm excitations. Under the 1.414 w₀ definition of uniform light sheet, the critical distances for uniform illumination were approximately 210 μm, approximately 320 μm and approximately 1000 μm for excitations of 658 nm, 785 nm and 1319 nm in mouse brain, respectively. The mouse brain tissue was prepared by injection of PEGylated PbS/CdS CSQD intravenously into a mouse, then the mouse was sacrificed at 30 min post injection, fixed the brain and preserved it in glycerol for further ex vivo observations.

FIGS. 16A-16J illustrate the effects of the excitation light sheet wavelength to optical sectioning along the depth Z direction of the NIR II light sheet screening.

FIGS. 16A and 16F illustrate X-Z and Y-Z cross sectional images of vasculatures reconstructed from X-Y images at various depth Z. The scanning step in Z was 5 μm. The fluorescence emission of PEGylated PbS/CdS CSQD in vasculatures was collected in 1500-1700-nm spectral window using a 10×, 0.25-NA detection objective and excitation was generated by a 5×, 0.15-NA illumination objective.

FIGS. 16B and 16C illustrate zoomed areas marked in FIG. 16A.

FIGS. 16D and 16E illustrate cross-sectional normalized intensity profiles of the arrow-marked structures shown in FIGS. 16B and 16C. These data show that feature smearing along Z is lower for longer wavelength light due to reduced scattering of light sheet in Z during propagation in glycerol-cleared brain tissue.

FIGS. 16F-16J illustrate the same results were at different imaging depths.

FIGS. 17A-17E illustrate wide-filed imaging of xenograft MC38 tumors expressing immune checkpoint protein PD-L1 on mice injected with anti-PD-L1-TT dye conjugate or renal-excretable free TT dye.

FIG. 17A illustrates a white-light photograph showing a subcutaneous xenograft MC38 tumor near the hind limb of a C57BL/6 mouse. Anti-PD-L1-TT or free TT dye was injected into a mouse intravenously and remained circulation for 24 h. 24 h post injection, PEGylated PbS/CdS CSQD was injected and imaged 30 min after injection using a wide-field setup in two channels.

FIG. 17B illustrates a control mouse intravenously injected with free TT dye (emission: 1000-1200 nm, excitation: 808 nm) without conjugation to any anti-PD-L1. 24 h later, it was injected with PEGylated PbS/CdS CSQD and then imaged in the TT dye and the CSQD channels. CSQDs were still circulating in the blood to give the vasculature images (green channel, 1500-1700 nm fluorescence). However, signal of free TT dye injected 24 h earlier was too weak to be imaged in the tumor (in the region with dashed circle) due to renal excretion.

FIG. 17C illustrates brighter dye signals (emission: 1000-1200 nm, excitation: 808 nm) observed in a MC38 tumor injected with anti-PD-L1-TT dye due to specific targeting of PD-L1 in the tumor, together with the vasculatures labeled by CSQDs in the 1500-1700 nm green channel.

FIG. 17D illustrates a magnified image of the tumor shown in FIG. 17C taken by another pair of achromatic lenses with larger magnification. Unlike LSM, wide-field imaging only provided 2D projected signals and lacked spatial resolution to resolve anti-PD-L1-TT distributions in tumors.

FIG. 17E illustrates in vivo two-color 3D light sheet microscopy of anti-PD-L1-TT (excitation: 785 nm, emission: 1000-1200 nm, exposure: 0.8 s) and vasculatures (PEGylated PbS/CdS CSQD, excitation: 1319 nm, emission: 1500-1700 nm, exposure: 0.8 s) in a MC38 tumor using a 10× detection objective and a 5× illumination objective. The Z scanning increment was 3 μm. Discrete red spots were down to 6×6×15 μm³ in size, corresponding to PD-L1 expressing cells inside the tumor. No such spots were observed in tumor injected with TT dye without any anti-PD-L1 conjugated.

FIGS. 18A-18E illustrates in vivo NIR-II light sheet microscopy of tumors and resolution calibration of NIR-II LSM for in vivo imaging.

FIG. 18A illustrates in vivo 3D light sheet microscopy of free TT (excitation: 785 nm, emission: 1000-1200 nm) and vasculatures (PEGylated PbS/CdS CSQD, excitation: 1319 nm, emission: 1500-1700 nm) in a MC38 tumor before wide-field imaging in FIG. 17B. The signal of remained free TT in the tumor was too weak to be seen due to renal excretion without specific binding to the tumor.

FIGS. 18B-18E illustrate in vivo optical sectioning (green for PEGylated PbS/CdS CSQD labelled vasculatures, red for anti-PD-L1-TT) by LSM of a MC38 tumor (50× detection objective) injected with anti-PD-L1-TT dye conjugate and PbS/CdS CSQD injected 24 h after the injection of anti-PD-L1-TT. Bright discrete spots correspond to binding of anti-PD-L1-TT dye conjugate to PD-L1 expressing cells in the M38 tumor. FWHMs in X-Y and X-Z planes were measured for resolution estimation.

FIGS. 18B and 18D illustrate the discrete anti-PD-L1-TT dye labelled features inside tumors show sub-6-μm FWHM in the lateral X-Y plane and sub-15-μm FWHM in Z under 785 nm excitation and 1000-1200 nm collection, suggesting cellular scale molecular imaging of PD-L1 in vivo.

FIGS. 18C and 18E illustrate the fluorescence signal of PEGylated PbS/CdS CSQD circulating in the vasculatures shows sub-5 μm×5 μm×10 μm volumetric resolution (FWHM) under 1319 nm excitation and 1500-1700 nm collection.

FIGS. 19A and 19B illustrate resolution calibration of NIR-II LSM for non-invasive mouse head imaging shown in FIG. 5A.

FIG. 19A illustrates cross-sectional normalized fluorescence intensity profiles of the smallest vessels (scatters) and Gaussian fit (solid lines) at the X-Y plane at different imaging depths. In this experiment, the mouse was intravenously injected with PEGylated PbS/CdS CSQD (excitation: 1319 nm, emission: 1500-1700 nm) and imaged by an oblique NIR-II LSM shown in FIG. 4E. Similar imaging were performed at 3 positions of mouse head in each of 2 mice (BALB/c, female, 4 weeks old), for a total n=6. A 5× illumination objective and a 10× detection objective were used and the scanning increment was 4 μm along the X direction.

FIG. 19B illustrates cross-sectional normalized fluorescence intensity profiles of the smallest vessels (scatters) and Gaussian fit (solid lines) along the Z direction at different imaging depths.

### DETAILED DESCRIPTION

This disclosure is not limited to particular embodiments described, and as such may, of course, vary. The terminology used herein serves the purpose of describing particular embodiments only, and is not intended to be limiting, since the scope of the present disclosure will be limited only by the appended claims.

Where a range of values is provided, each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Embodiments of the present disclosure will employ, unless otherwise indicated, techniques of medicine, organic chemistry, biochemistry, molecular biology, pharmacology, and the like, which are within the skill of the art. Such techniques are explained fully in the literature.

The following examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

Before the embodiments of the present disclosure are described in detail, it is to be understood that, unless otherwise indicated, the present disclosure is not limited to particular materials, reagents, reaction materials, manufacturing processes, dimensions, frequency ranges, applications, or the like, as such can vary. It is also to be understood that the terminology used herein is for purposes of describing particular embodiments only, and is not intended to be limiting. It is also possible in the present disclosure that steps can be executed in different sequence, where this is logically possible. It is also possible that the embodiments of the present disclosure can be applied to additional embodiments involving measurements beyond the examples described herein, which are not intended to be limiting. It is furthermore possible that the embodiments of the present disclosure can be combined or integrated with other measurement techniques beyond the examples described herein, which are not intended to be limiting.

It should be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

Each of the applications and patents cited in this text, as well as each document or reference cited in each of the applications and patents (including during the prosecution of each issued patent; “application cited documents”), and each of the PCT and foreign applications or patents corresponding to and/or claiming priority from any of these applications and patents, and each of the documents cited or referenced in each of the application cited documents, are hereby expressly incorporated herein by reference. Further, documents or references cited in this text, in a Reference List before the claims, or in the text itself; and each of these documents or references (“herein cited references”), as well as each document or reference cited in each of the herein-cited references (including any manufacturer's specifications, instructions, etc.) are hereby expressly incorporated herein by reference.

Prior to describing the various embodiments, the following definitions are provided and should be used unless otherwise indicated.

### Abbreviations

LSM, Light Sheet Microscope (Microscopy); LSFM, Light Sheet Fluorescence Microscope (Microscopy); Full Width at Half Maximum, FWHM; NIR, Near infra-red; NA, numerical aperture; InGaAs, Indium Gallium Arsenide; PEG, polyethylene glycol; SBR, signal:background ratio; CSQD, core-shell quantum dot; 3D, three-dimensional; PD-L1, programmed-death ligand 1; PD-1, Programmed cell death protein 1; BST, blood supply time; FOV, field of view; NaErF4, Erbium rare-earth nanoparticles; TBI, traumatic brain injury

### Definitions

The term “achromatic lens” or “achromat” as used herein refers to a lens that is designed to limit the effects of chromatic and spherical aberration. Achromatic lenses are corrected to bring two wavelengths (typically red and blue) into focus on the same plane.

The term “biological sample” as used herein refers to an isolated or cultured cell or population of cells, an isolated tissue or organ removed from an animal or human subject, or an animal or human subject living or dead. The term biological sample can refer to a sample of plant or animal origin.

The term “biomarker” as used herein refers to an antigen such as, but not limited to, a peptide, polypeptide, protein (monomeric or multimeric) that may be found on the surface of a cell, an intracellular component of a cell, or a component or constituent of a biofluid such as a soluble protein in a serum sample and which is a characteristic that is objectively measured and evaluated as an indicator of a tumor or tumor cell. The presence of such a biomarker in a biofluid or a biosample isolated from a subject human or animal can indicate that the subject is a bearer of a cancer. A change in the expression of such a biomarker may correlate with an increased risk of disease or progression, or predictive of a response of a disease to a given treatment. Exemplary biomarkers useful in the systems and methods of the disclosure can be, but are not limited to, such as activin A; IL-18 BPa, adiponectin/acrp30, IL-18 receptor α/IL-1 R5, AgRP, IL-18 receptor β/AcPL, ALCAM, IL-2 receptor α, angiogenin, IL-2 receptor α, AR (amphiregulin), IL-3, Axl, IL-4, B7-1/CD80, I-TAC/CXCL11, BCMA/TNFRSF17, leptin (OB), BDNF, LIF, β-NGF, LIGHT/TNFSF14, BLC/BCA-1/CXCL13, LIGHT/TNFSF14, BMP-5, MCP-2, BTC, MCP-3, cardiotrophin-1/CT-1, MCP-4/CCL13, CTLA-4/CD152, M-CSF, CXCL16, MMP-10, Dtk, MMP-13, EGF, MMP-9, EGF receptor/ErbB1, MSP α-chain, endoglin/CD105, MSP β-chain, eotaxin/CCL11, NAP-2, eotaxin-2/MPIF-2, NGF R, eotaxin-3/CCL26, NT-4, ErbB3, OSM, Fas/TNFRSF6, osteoprotegerin, Fas Ligand, PDGF receptor β, FGF Basic, PDGF-AA, FGF-4, PDGF-AB, FGF-6, PDGF-BB, FGF-7/KGF, PIGF, FGF-9, P-selectin, follistatin, RAGE, GITR/TNFRF18, RANTES, HB-EGF, SCF, HCC-4/CCL16, SCF receptor/CD117, HGF, sgp130, 1-309, Siglec-9, IGFBP-1, siglec-5/CD170, IGFBP-2, Tarc, IGFBP-3, TGFα, IGF-I, TNF RI/TNFRSF1A, IGF-I, TNF RII/TNFRSF1B, IGF-I S receptor, TNFβ, IGF-II, TRAIL R1/DR4/TNFRSF 10/, IGF-II, TRAIL R3/TNFRSF 10C, IL-1α, TRAIL R4/TNFRSF 10D, IL-1β, TRANCE, IL-1 R4/ST2, TREM-1, IL-1 sRI, TROP/TNFRSF19, IL-1 sRI, uPAR, IL-10, VCAM-1 (CD106), IL-10 receptor β, VE-cadherin, IL-13 receptor α1, VEGF, IL-13 receptor α2, VEGF R2 (KDR), IL-17, VEGF R3, and the like, or any combination thereof. It is considered within the scope of the disclosure for a cancer or cancer cell to be characterized by at least one biomarker and more typically by a plurality (a panel) of such markers.

The term “contacting” as used herein refers to any method that places a biological sample to be examined by the apparatus and methods of the disclosure in physical contact with a probe as herein disclosed. Isolated cells and tissues, for example, may be immersed in a solution or suspension of the probe or nanoparticle probe whereupon the probe may attach to or be absorbed by the sample. Organs isolated from an animal or human subject may, for example, be immersed in a probe solution or the solution can be delivered to throughout all or part of the organ through the vasculature of the organ. Similarly, the probe composition may be administered to an animal or human subject by intravascularly, subcutaneously, or by any other method know to one of skill in the art.

The term “dye” as used herein refers to any reporter group whose presence can be detected by its light absorbing or light emitting properties. For example, Cy5 is a reactive water-soluble fluorescent dye of the cyanine dye family. Cy5 is fluorescent in the red region (about 650 to about 670 nm). It may be synthesized with reactive groups on either one or both of the nitrogen side chains so that they can be chemically linked to either nucleic acids or protein molecules. Labeling is done for visualization and quantification purposes. Cy5 is excited maximally at about 649 nm and emits maximally at about 670 nm, in the far red part of the spectrum; quantum yield is 0.28. FW=792. Suitable fluorophores (chromes) for the probes of the disclosure may be selected from, but not intended to be limited to, fluorescein isothiocyanate (FITC, green), cyanine dyes Cy2, Cy3, Cy3.5, Cy5, Cy5.5 Cy7, Cy7.5 (ranging from green to near-infrared), Texas Red, and the like. Derivatives of these dyes for use in the embodiments of the disclosure may be, but are not limited to, Cy dyes (Amersham Bioscience), Alexa Fluors (Molecular Probes, Inc.), HILYTE™ Fluors (AnaSpec), and DYLITE™ Fluors (Pierce, Inc.).

The term “fluorescence” as used herein refers to a luminescence that is mostly found as an optical phenomenon in cold bodies, in which the molecular absorption of a photon triggers the emission of a photon with a longer (less energetic) wavelength. The energy difference between the absorbed and emitted photons ends up as molecular rotations, vibrations or heat. Sometimes the absorbed photon is in the ultraviolet range, and the emitted light is in the visible range, but this depends on the absorbance curve and Stokes shift of the particular fluorophore.

Spectroscopic, photochemical, biochemical, immunochemical, electrical, optical or chemical means can be used to detect such labels. The detection device and method may include, but is not limited to, optical imaging, electronic imaging, imaging with a CCD camera, integrated optical imaging, and mass spectrometry. Further, the amount of labeled or unlabeled probe bound to the target may be quantified. Such quantification may include statistical analysis.

The term “fluorophore” as used herein refers to any reporter group whose presence can be detected by its light emitting properties. The term “contrast agent” as used herein refers to an agent that when delivered to a cell, a tissue, or an animal or human subject can improve the image.

The term “light sheet microscopy” as used herein refers to illumination done perpendicularly to the direction of observation. The expanded beam of a light, most advantageously, but not limited to, a laser light is focused in only one direction by a cylindrical lens, or by a combination of a cylindrical lens and a microscope objective as the latter is available in better optical quality and with higher numerical aperture than the first. This way a thin sheet of light or “light sheet” is created in the focal region that can be used to excite fluorescence only in a thin slice (usually a few micrometers thin) of the sample.

In light sheet fluorescence microscopy (LSFM) the sheet of light that illuminates the specimen is orthogonal to the detection path and only fluorophores close to the focal plane of the detection system are detectable. By reducing photobleaching effects while imaging, the specimen is exposed to 5000 times less energy than in a confocal microscope. The light sheet stage allows for 3-dimensional movement and rotation around a vertical axis, such that imaging from all angles can be possible. Additionally, data acquisition in LSFM technology allows the detector to collect all pixels in one image as opposed to one pixel at a time, which has a great impact on the rate of image acquisition (100 frames per second) in contrast to the confocal at 1-5 frames per second. As a result, LSFM permits lengthier imaging time course experiments.

The term “nanoparticle” as used herein refers to a particle having a diameter of between about 1 nm and about 1000 nm, preferably between about 100 nm and 1000 nm, and most preferably between about 50 nm and 700 nm. Similarly, by the term “nanoparticles” is meant a plurality of particles having an average diameter of between about 50 nm and about 1000 nm.

The term “orthogonal” as used herein refers to two objects having axes, wherein the axes are at right angles to each other.

The term “molecular target” as used herein refers to a molecule that can be specifically bound by a ligand such as, but not limited to, a peptide, protein, nucleic acid, or a small molecule ligand. The target may be specific to or concentrated in or on a cell, a tissue, or an animal tissue, organ, or cell type compared to other tissues, organs, or cell types of the animal subject. A molecular target may be a biomarker.

The term “quantum dot” (quantum dots) as used herein refers to semiconductor nanocrystals or artificial atoms, which are semiconductor crystals that contain anywhere between 100 to 1,000 electrons and range from about 2 to about 10 nm. Some quantum dots can be between about 10 to about 20 nm in diameter. Quantum dots have high quantum yields, which makes them particularly useful for optical applications. Quantum dots are fluorophores that fluoresce by forming excitons, which can be thought of as the excited state of traditional fluorophores, but which have much longer lifetimes of up to 200 nanoseconds. This property provides quantum dots with low photobleaching. The energy level of quantum dots can be controlled by changing the size and shape of the quantum dot, and the depth of the quantum dots' potential. One of the optical features of small excitonic quantum dots is coloration, which is determined by the size of the dot. The larger the dot, the redder, or more towards the red end of the spectrum the fluorescence. The smaller the dot, the bluer or more towards the blue end it is. The bandgap energy that determines the energy and hence the color of the fluoresced light is inversely proportional to the square of the size of the quantum dot. Larger quantum dots have more energy levels which are more closely spaced, thus allowing the quantum dot to absorb photons containing less energy, i.e. those closer to the red end of the spectrum. Because the emission frequency of a dot is dependent on the bandgap, it is therefore possible to control the output wavelength of a dot with extreme precision. Colloidally prepared quantum dots are free floating and can be attached to a variety of molecules via metal coordinating functional groups. These groups include but are not limited to thiol, amine, nitrile, phosphine, phosphine oxide, phosphonic acid, carboxylic acids or other ligands. By bonding appropriate molecules to the surface, the quantum dots can be dispersed or dissolved in nearly any solvent or incorporated into a variety of inorganic and organic films.

The terms “subject”, “individual”, or “patient” as used herein are used interchangeably and refer to a cell, a tissue, or an animal preferably a warm-blooded animal such as a mammal. Mammal includes without limitation any members of the Mammalia. A mammal, as a subject or patient in the present disclosure, can be from the family of Primates, Carnivora, Proboscidea, Perissodactyla, Artiodactyla, Rodentia, and Lagomorpha. In a particular embodiment, the mammal is a human. In other embodiments, animals can be treated; the animals can be vertebrates, including both birds and mammals. In aspects of the disclosure, the terms include domestic animals bred for food or as pets, including equines, bovines, sheep, poultry, fish, porcines, canines, felines, and zoo animals, goats, apes (e.g. gorilla or chimpanzee), and rodents such as rats and mice.

The term “upconverting nanoparticle (UCNP)” as used herein refers to nanoscale particles that exhibit photon upconversion. In photon upconversion, two or more incident photons of relatively low energy are absorbed and converted into one emitted photon with higher energy. Generally, absorption occurs in the infrared, while emission occurs in the visible or ultraviolet regions of the electromagnetic spectrum. UCNPs are usually composed of lanthanide- or actinide-doped transition metals and are of particular interest for their applications in bio-imaging and bio-sensing at the deep tissue level. Upconversion can take place in both organic and inorganic materials, through a number of different mechanisms. Organic molecules that can achieve photon upconversion through triplet-triplet annihilation are typically polycyclicaromatic hydrocarbons (PAHs). Inorganic materials capable of photon upconversion often contain ions such as Ln³⁺, Ti²⁺, Ni²⁺, Mo³⁺, Re⁴⁺, Os⁴⁺, and the like.

### Discussion

Near-infrared-II Light Sheet Microscopy through Scattering Tissues: The present disclosure encompasses a method of three-dimensional (3D) fluorescence imaging in the visible by light sheet microscopy (LSM), a powerful tool for biological imaging with high spatiotemporal resolution. Optical excitation and emission wavelengths were extended up to approximately 1320 nm and to at least 1700 nm respectively into the NIR-II (800-2400 nm) region for near-infrared (NIR) light sheet microscopy through scattering tissues. Suppressed scattering of both excitation and emission photons allowed optical sectioning at greater than 2 mm depth in non-cleared brain tissues. NIR-II LSM enabled non-invasive in vivo imaging of live mice, revealing never-before-seen dynamic processes such as highly abnormal tumor microcirculation, and 3D molecular imaging of an important immune checkpoint protein, programmed-death ligand 1 (PD-L1) receptors at the single cell scale in tumors. In vivo two-color near-infrared light sheet sectioning enabled simultaneous volumetric imaging of tumor vasculatures and PD-L1 proteins in live mammals.

Near-infrared optical sectioning of live mammals in three dimensions: Mammals show high genetic similarity to humans and have been widely used for disease model studies. However, light scattering has limited 3D light sheet microscopy to imaging small transparent animals or cleared tissues ex vivo. Non-invasive in vivo 3D optical sectioning of live mammals with high spatiotemporal resolution has been challenging. Near-infrared light sheet microscopy was developed with optical excitation and emission wavelengths in the 1000-1700 nm, greatly suppressing light scattering by tissues for in vivo approximately 10 mm³ volumetric imaging of live mice with single cell resolution. Highly abnormal tumor microcirculation dynamics and molecular distribution of programmed-death ligand 1 (PD-L1) receptors were revealed in live tumors.

The present disclosure encompasses NIR-II LSM developed using organic dyes and PbS/CdS core/shell quantum dot (CSQD) probes, extending excitation and emission to the approximately 785-1320 nm and approximately 1000-1700 nm regimes respectively. However, the methods herein described can be readily adapted for other fluorescent labels that can be targeted to specific cells, tissues or organs by conjugating the label(s) to ligands having specific binding affinity for the desired target.

Suppressed light scattering of both excitation and emission allowed up to 10 mm³ volumetric imaging of mouse brain with a penetration depth of at least 2 mm. NIR LSM readily afforded in vivo imaging of mouse tumor models non-invasively, enabling real-time observation of unusual tumor microcirculation, and 3D molecular imaging of immune checkpoint proteins at cellular scale in live mammals.

The LSM methods of the disclosure can use multiple switchable lasers with Gaussian beams (658 nm, 785 nm and 1319 nm) cylindrically focused into static light sheets for optical sectioning and an InGaAs camera for orthogonally detecting 900-1700 nm fluorescence (FIGS. 1A, and 6A-6B). The effective numerical apertures of illumination objectives can be adjusted to produce light sheets with balanced waist thickness (approximately 10-20 μm) and Rayleigh length (approximately 0.5-2.0 mm), suitable for large scale volumetric imaging with single cell resolution. Several biocompatible NIR-II probes can be used such as an organic nanofluorophore p-FE (Wan et al., Nat. Commun. 9: 1171 (2018)) (excitation/emission: 650-850 nm/1000-1300 nm, FIGS. 1B, and 7A-7D, dynamic light scattering size approximately 12 nm) and PEGylated PbS/CdS CSQD probes (Zhang et al., Proc. Natl. Acad. Sci. USA 115: 6590-6595 (2018)) (excitation/emission: ultraviolet to 1500 nm/1500-1700 nm, FIGS. 1B, and 7A-7D, size approximately 6.9 nm). For example, the two probes were sequentially injected intravenously into a mouse through the tail-vein at an interval of 5 min. The mouse was sacrificed at 30 min post-injection while the probes were still circulating in the vasculature, the brain was fixed and placed in glycerol for ex vivo LSM imaging. Under the same 785 nm light sheet (LS) excitation, the cerebral vasculatures were clearly imaged as a function of tissue depth Z in three fluorescence emission windows 850-1000 nm (NIR-1, p-FE emission), 1100-1200 nm (NIR-IIa, p-FE emission) and 1500-1700 nm (NIR-IIb, CSQD emission) respectively (FIG. 10). This allowed side-by-side comparison (FIG. 10) of fluorescence LSM imaging in three sub-regions of 850-1700 nm under the same 785 nm LS excitation. Note that refractive index mismatch during scanning was compensated by linearly moving detection objective (FIGS. 8A-9B).

With a 785 nm light sheet, the glycerol-cleared brain tissue imaging depth limit increased (FIG. 10), background signal decreased (FIG. 1D) and the SBR increased (FIG. 1E) at longer detection wavelength from 850-1000 nm to 1100-1200 nm and 1500-1700 nm. The imaging depth limit (defined as tissue depth at which the SBR decreased to approximately 2) increased from Z_{SBR=2} approximately 1.0 mm to approximately 2.0 mm and approximately 2.5 mm as emission wavelength increased from approximately 850 nm to approximately 1100 nm and approximately 1700 nm (FIG. 1E). These were direct results of suppressed scattering of emission photons (scattering∝λ^{-k} where A is wavelength and k is in the range of 0.2-4.0 for biological tissues) (Hong et al., Nat. Photonics 8: 723-730 (2014)) under the same 785 nm excitation. Background signal caused by scattering was the lowest in the 1500-1700 nm emission range at all imaging depths (Z up to 3 mm, FIG. 1D). For emission in the 850-1200 nm range, background signal increased with tissue imaging depth up to Z=approximately 1 mm due to increased scattering by thicker tissue and decreased upon further increases in depth for Z greater than 1 mm (FIG. 1D). The latter was attributed to increased light absorption by thicker tissue that attenuated the background signal.

The lateral full width at half maximum (FWHM) values of the smallest cerebral vasculatures imaged in the three emission regions (850-1000 nm, 1100-1200 nm and 1500-1700 nm, FIG. 1F) at their tissue imaging depth limits of Z_{SBR=2}=1.0 mm, 2.0 mm and 2.5 mm were approximately 7.2 μm, 9.0 μm and 8.3 μm respectively. Using an imaging objective with high magnification and numerical aperture (NA), less than 5.0 μm lateral FWHM was achieved by NIR-LSM imaging by detecting 1500-1700 nm emission under a 785 nm LS illumination (FIG. 10). This was the first time that one-photon imaging reached micron scale spatial resolution at greater than 2 mm depths through highly scattering non-cleared mouse brain tissues (FIGS. 1F and 10B).

As a light sheet propagated in a scatting medium such as an intralipid phantom (van Staveren et al., Appl. Opt. 30: 4507-4514 (1991); Johns et al. Opt. Express 13: 4828-4842 (2005)) mimicking the glycerol-cleared brain tissue, Monte Carlo simulations (Johns et al. Opt. Express 13: 4828-4842 (2005)) and experiments showed light sheet decaying in intensity in the X-Y plane and spreading in Z due to tissue scattering (FIGS. 2A, 2C, 2D, 11A-14), which could hinder optical sectioning capability with reduced imaging field of view in X-Y and lower spatial resolution in Z. To circumvent this and maximize the benefit of reduced photon scattering at long wavelengths, a 1320 nm light sheet was constructed to afford the lowest degree of intensity decay and the least LS thickness broadening relative to the 785 nm and 658 nm light sheets (FIGS. 2A, 2C, 2D, and 12A-14). In the fixed brain tissue, 658 nm, 785 nm and 1319 nm light sheets propagated over a distance of approximately 1.3 mm, approximately 1.7 mm and approximately 4.0 mm respectively (FIG. 2A), within which imaging of cerebral vasculatures by detecting 1500-1700 nm fluorescence of PbS/CdS core-shell quantum dots could still resolve small vessels (FWHM less than 10 μm). Such imaging used an important property of quantum dots, i.e., ultra-wide excitation ranges (ultraviolet to greater than 1300 nm) (FIG. 6). The 1319 nm light sheet could propagate greater than 6 mm to allow imaging of large blood vessels in the non-cleared mouse brain over large field of views (FIG. 2A). Suppressed scattering of longer wavelength LS was also gleaned from X-Y, X-Z or Y-Z cross sectional images (FIGS. 2E and 15A-15F), with improved SBR (FIG. 2F) and reduced FWHM of feature sizes along the depth Z direction, corresponding to higher vertical resolution and better sectioning capability along Z (FIGS. 15E and 15F).

Three-dimensional light sheet microscopy of mouse brain (FIGS. 3A-3C) using 1319 nm excitation and 1500-1700 nm detection was the first time any one-photon technique used an optical excitation greater than 1000 nm. Light sheet microscopy with both excitation and emission in the 1000-1700 nm NIR-II window minimized scattering and maximized the penetration depth and field of view. High resolution 3D NIR-II LSM sectioning (FIG. 3A, volume=810 μm×648 μm×3000 μm, 3 μm Z increment in depth) afforded sub-10 μm×10 μm×15 μm volumetric resolution (FWHM) (FIGS. 1F, 15E, and 15F).

Under the 785 nm LS excitation, the maximum 1500-1700 nm fluorescence signal detected in the cerebral vasculatures of mouse brain cortex layer as a function of depth Z showed two attenuation regions (FIG. 3C). There was an initial exponential attenuation due to reduction in ballistic and nearly ballistic photons (slightly deflected) emerging through the tissue following the Beer-Lambert law I_{ball}=I₀e^{-z/s} (where z is imaging depth, I₀ is initial intensity at z=0 mm and Iₛ is scattering mean free path MFP). This was followed by a slower decay region at deeper Z from which multiply scattered photons diffusing through the brain tissue (diffusive region) were dominant (Shi & Alfano (CRC Press, (2017)). The MFP Iₛ extracted (FIG. 3C) for glycerol-cleared brain tissue was approximately 305 μm, approximately 440 μm and approximately 639 μm in the 850-1000 nm, 1100-1200 nm and 1500-1700 nm windows respectively, about twice of that of non-cleared brain tissue (Song et al., Opt Laser Technol 73: 69-76 (2015)). The imaging penetration depth limits (see Supplementary Table 1 for detailed scattering coefficients and MFP comparison) were 2.5/ₛ (for 850-1000 nm emission), ˜2.6/ₛ (for 1100-1200 nm emission) and ˜3.3/ₛ (for 1500-1700 nm emission).

The capability of NIR-II LSM performing volumetric imaging through scattering tissues at the 1-10 mm³ scale enabled non-invasive in vivo 3D imaging of protruding features on live mice related to disease models (FIG. 4B), facilitating cellular resolution LS sectioning through intact tissues for mammals. NIR LSM imaging of subcutaneous xenograft tumors was carried out on mice ear and right/left flank of back without invasive surgery or installing optical windows (Maeda et al., Plos One 7, e42133 (2012)). Non-invasive in vivo hemodynamic imaging of a tumor model used for immunotherapy, murine colorectal MC38 tumors on C57BL/6 mice ear was carried out with the NIR-II light sheet fixed at a Z position approximately 300 μm below the top (where the fluorescence signal was first detected) of the tumor (approximately 8 mm in diameter, FIGS. 4A and 4B). Time-course LS imaging of the p-FE nanofluorophore immediately following intravenous injection into the mouse tail-vein (785 nm excitation, 1000 nm detection at exposure times of between about 100 ms and about 800 ms) revealed abnormal microcirculation in tumor. Blood flows in tumor vasculatures were found irregular and intermittent (FIGS. 4A and 4C), with turning-on and shutting-off behavior, oscillatory/fluctuating flowing patterns and even flow direction reversal in the same vasculature (FIG. 4C, marked by arrows). Intermittent blood flows was only inferred from ex vivo histological methods previously (Song et al., Opt Laser Technol 73: 69-76 (2015)), suggesting unstable pressure within a tumor due to uncontrolled tumor angiogenesis. Further, blood supply time (BST) analysis revealed that the p-FE nanofluorophore gradually leaked out from some vasculatures but not from others (FIG. 4D).

To further exploit NIR-II LSM, in vivo two-color molecular imaging and vasculature imaging of PD-L1 expressing MC38 tumor (Tang et al., Cancer Cell 29: 285 (2016)) was performed using a renal excretable organic dye (Zhang et al., Adv. Mater. 28; 6872 (2016); Weizhi et al., Adv. Mater. 0, 2400106 (2018)) (TT dye: excitation approximately 785 nm/emission approximately 1000-1200 nm) conjugated to anti-PD-L1 antibodies and unconjugated PEGylated PbS/CdS CSQD (excitation approximately 1319 nm/emission 1500-1700 nm) intravenously injected into tumor bearing mice. PD-L1 is an important immune checkpoint protein expressed by tumors as a powerful way of T cell immunity evasion. PD-L1 blocking by antibody immunotherapy is a novel approach to treat various cancers. In vivo PD-L1 imaging is important to fundamental understanding of cancer immunity, and to immunotherapy prognosis since treatment efficacy correlated with PD-L1 levels in the tumor (Balar & Weber, Cancer Immunol. Immun. 66: 551 (2017); Song et al., Plos One 8, e65821 (2013)). 24 h post injection of anti-PD-L1-TT dye, wide-field imaging was first performed resulting in much brighter anti-PD-L1-TT dye signals in MC38 tumors (36) (FIG. 4E) than post injection of the unconjugated free TT dye (FIG. 16B). Since wide-field imaging only provided 2D projected signals and lacked spatial resolution, 3D in vivo NIR LSM was used to profile PD-L1 receptors at various depths of the tumor (FIG. 4F) inside the live mouse, a task only done with tumor biopsies previously (Kleinovink et al., Oncoimmunol. 6: (2017); Mahoney et al., Cancer Immunol. Res. 3: 1308 (2015); Schats et al., Histopathology 70: 253 (2017)). Discrete anti-PD-L1-TT dye labelled features were seen inside tumors with sub-6-μm FWHM in the lateral X-Y plane and sub-15-μm FWHM in Z using a 50× detection objective (FIGS. 17B and 17D), suggesting cellular scale molecular imaging of PD-L1 in vivo. Meanwhile, irregular tumor blood vessels engulfing PD-L1 expressing cells were imaged upon intravenously injecting PEGylated PbS/CdS CSQD (excitation 1319 nm/emission 1500-1700 nm) circulating in the vasculatures with sub-5 μm×5 μm×10 μm volumetric resolution (FWHM) (FIGS. 17C and 17E). The results suggested tumor extravasation of anti-PD-L1-TT dye (injected 24 h prior to CSQD injection) and specific targeting of PD-L1 expressing cells in the tumor of a live mouse.

PD-L1 is an important immune checkpoint protein expressed by certain tumors as a powerful way of cancer evasion of a body's immune surveillance through PD-L1 (on tumor) and PD-1 (on T cells) binding (Balar & Weber Cancer Immunol. Immun. 66: 551-564 (2017)). PD-L1 blocking by antibody immunotherapy is a breakthrough approach to activate the immune system and treat cancer. In vivo PD-L1 imaging/mapping is important to fundamental understanding of cancer immunity and immunotherapy mechanism (Balar & Weber Cancer Immunol. Immun. 66: 551-564 (2017); Song et al., Plos One 8: e65821 (2013)). To this end, a 45° oblique NIR-II LSM was developed (FIGS. 4E and 6A-6B) and performed non-invasive in vivo three-plex molecular imaging of PD-L1 expressing CT26 tumor (Tang et al., Cancer Cell 29: 285-296 (2016)).

An erbium-based rare-earth nanoparticles (ErNPs) (Zhong. et al., Nat. Commun. 8: 737 (2017)) (excitation 975 nm/emission 1500-1700 nm, see Method) conjugated to PD-L1 antibodies were injected intravenously and 24 h later, PEGylated PbS/CdS CSQD conjugated to anti-PD-1 (excitation about 1319 nm/emission 1500-1700 nm) were injected. At 2 h post injection, dynamic imaging into the tumor at a fixed illumination plane by oblique NIR-II LSM (FIG. 4E) observed a single PD-1+ T cell (labeled by PEGylated PbS/CdS CSQDs) circulating in tumor vasculatures irregularly and following blood flow direction reversal (FIG. 4F). In another 27 h, p-FE was injected intravenously for labeling tumor vessels. Wide-field imaging was first used to image PD-L1 and PD-1 labelled by anti-PD-L1-ErNPs and anti-PD-1-CSQD respectively (FIG. 4G), and fluorescence signals of ErNPs and PbS/CdS CSQD (both in 1500-1700 nm range) were differentiated by resolving the vastly different lifetimes of the two probes (about 5 ms for ErNPs and about 20 μs for PbS). Three-plex oblique NIR-II LSM was then performed to profile the 3D spatial distribution of PD-L1, PD-1 and vasculatures (labeled by circulating p-FE in 1100-1300 nm channel) in tumor (FIG. 4H) through the intact skin on the tumor without installing invasive window chamber (FIG. 4I). PD-1 expressing T cells were seen to be extravasated out of vessels (FIG. 4H) and surrounding PD-L1 expressing cells in the tumor, an important step in initiating cancer cell killing immunotherapeutic effect (FIGS. 4H and 4J). These results demonstrated multiplexed molecular imaging in 3D using oblique NIR-II LSM, which can be particularly useful for longitudinal imaging over long times due to its non-invasive nature. With this modality, sub-6-μm FWHM in the lateral X-Y plane and sub-15-μm FWHM in Z using a 50× detection objective can be realized (FIGS. 17A-18E), useful for cellular scale molecular imaging of multiple targets in vivo.

Strong scattering of light by scalp/skull typically required scalp removal (Wang et al., Nat. Methods 15: 789-792 (2018); Kawakami et al., Biomed. Opt. Express 6: 891-901 (2015)). To demonstrate non-invasive oblique NIR-II LSM into non-protruding tissues, an intact mouse head was imaged through the layers of scalp, skull, meninges and brain cortex, 2 h post injection of PEGylated PbS/CdS CSQD probes (FIGS. 5A and 5B). The 1319-nm illumination and 1500-1700-nm fluorescence detection afforded a penetration depth of about 774 μm along the tilted light sheet direction into the head using a 10× imaging objective (FIG. 5C) with 7-15-μm FWHM in X-Y plane and 7-17-μm FWHM along Z direction, gleaned by measuring the smallest vessels (FIGS. 19A and 19B). In the meninges, interesting vascular channel like structures connecting the skull bone and brain cortex (marked by triangles in FIGS. 5A and 5D) were observed. These channels could be of importance to the recently revealed immune system of the brain and were resolved here for the first time by a non-invasive LSM imaging in vivo.

Further, in a mouse model of TBI (Zhang et al., Adv. Mater. 28: 6872-6879 (2016)) (FIG. 5E), the meningeal macrophages/microglia were labelled by intravenously injected anti-CD11b-PEGylated PbS/CdS CSQD 2 h after injury. At 24 h post injection, non-invasive 3D time-course LSM imaged/monitored the recruitment of meningeal macrophages/microglia to the injured site as an inflammatory response (Russo & McGavern Science 353: 783-785 (2016) (FIG. 4F)).

The disclosure encompasses 3D near-infrared light sheet microscopy for in vivo and ex vivo deep tissue volumetric imaging through highly scattering biological tissues. Light sheet microscopy with both excitation and emission in the NIR-II window avoided shadows or stripes along the illumination direction by suppressing tissue scattering and adsorption effects encountered by visible LSM (Russo et al., Science 353: 783-785 (2016)). Non-invasive NIR-II LSM enabled in vivo observation of dynamic processes and molecular imaging at cellular scale. NIR LSM imaging can be further advanced by developing brighter fluorophores with added colors and applying new configurations of LSM (Itoh et al., Opt. Lett. 41: 5015-5018 (2016)). Recent developments such as non-coherent structured illumination (Tomer et al., Cell 163: 1796-1806 (2015)) and optical lattices illumination (Liu et al. Science 360, 1392 (2018)) could be introduced to improve the resolution and contrast of NIR-II LSM. Real time molecular imaging of multiple targets by rapid sectioning 3D tissues of live mammals should become possible.

Accordingly, one aspect of the disclosure, therefore, encompasses embodiments of a method of optically sectioning a biological sample, the method comprising the steps: (a) contacting a biological sample with a fluorescent contrast agent having an excitation wavelength of between about 785 nm to about 2400 nm and a fluorescence emission having a wavelength of between about 800 nm to about 2400 nm; (b) irradiating the biological sample with at least one excitation light having a wavelength of between about 785 nm to about 2400 nm, wherein the excitation light is configured as a static light sheet and directed through a first plane of the biological sample; (c) orthogonally detecting an emitted fluorescence having a wavelength of between about 800 nm to about 2400 nm from the irradiated biological sample; and (d) generating a first digital image of the fluorescence from the irradiated first plane through the biological sample.

In embodiments of this aspect of the disclosure, the biological sample can be an isolated cell or population of isolated cells, a cultured cell or population of cultured cells, an isolated tissue or organ, or an animal or human subject.

In some embodiments of this aspect of the disclosure, the biological sample has raised features and the irradiated biological sample is imaged by transmitting the light sheet through the raised feature from a side thereof and detecting the emitted fluorescence at right angles to the plane of the illuminating light sheet.

In some embodiments of this aspect of the disclosure, the biological sample can have substantially planar regions and the irradiated biological sample can be illuminated by the light sheet at an angle with respect to the normal to the planar region and the emitted fluorescence is detected at right angles to the plane of the illuminating light sheet.

In some embodiments of this aspect of the disclosure, the fluorescent contrast agent can be administrated by vascular delivery to a tissue or organ of the animal or human subject.

In some embodiments of this aspect of the disclosure, the fluorescent contrast agent can be conjugated to a targeting ligand that can specifically bind to a molecular target.

In some embodiments of this aspect of the disclosure, the targeting ligand can have an affinity for a molecular target and is selected from an antibody, a peptide, an aptamer, or a nucleic acid.

In some embodiments of this aspect of the disclosure, the targeting ligand can be an antibody or fragment thereof selectively binding to an epitope of a polypeptide selected from the group consisting of: Programmed cell death protein 1 (PD-1), Programmed death-ligand 1 (PD-L1), and CD11b.

In some embodiments of this aspect of the disclosure, the fluorescent contrast agent can emit at a wavelength of between about 900 to about 2400 nm and can be an organic molecular dye, a conjugated polymeric dye, a polymer micelle-wrapped organic nanofluorophore, a carbon nanotube, a quantum dot, or a rare-earth down-conversion or up-conversion nanoparticle.

In some embodiments of this aspect of the disclosure, the method can further comprise the steps: (i) repeating steps (b)-(d), thereby irradiating a plurality of parallel planes perpendicular to the light sheet plane at various depths through the biological sample, and generating a plurality of digital images; and (ii) digitally combining the plurality of digital images to generate a three-dimensional image of the location of the fluorescence emitted by the contrast agent in the biological sample.

In some embodiments of this aspect of the disclosure, the excitation light can be delivered to biological sample by an illumination objective, wherein the numerical aperture (N.A) of the objective is configured to deliver the excitation light as a light sheet having a balanced waist thickness of between about 5 μm to about 20 μm and a Rayleigh length of between about 0.1 mm to about 6.0 mm.

In some embodiments of this aspect of the disclosure, the excitation light can be generated by a laser having a wavelength of between about 700 nm and about 2400 nm.

Another aspect of the disclosure encompasses embodiments of a light sheet microscope comprising along an optical axis: an illumination objective positioned to direct an excitation light sheet through a plane of a biological sample; a plurality of achromatic lenses optimized for transmission of light between about 785 nm to about 2400 nm; a proximal first adjustable mechanical slit; a cylindrical lens; a distal second adjustable mechanical slit adjacent to the cylindrical lens and distal to the illumination objective, wherein the slit of said second slit is orientated at right-angles to the slit of the first slit; a pinhole; at least one excitation light source in the 600-2400 nm range; and at least one removable mirror disposed to direct an excitation light from the at least one light source along the optical axis of the illumination objective, the plurality of achromatic lenses, the proximal first adjustable mechanical slit, the cylindrical lens, the distal second adjustable mechanical slit, and the pinhole; a detection objective disposed to orthogonally receive fluorescent light emitted from a target irradiated by a light sheet from the illumination objective and to direct said fluorescent light to a detector operably connected to a computer system for generating a digital image of the fluorescent light; and at least one emission filter configured to only transmit fluorescent light having a wavelength of between about 785 nm to about 2400 nm.

In some embodiments of this aspect of the disclosure, the light sheet microscope can further comprise a right-angle prism disposed between the biological sample and the illuminating and receiving lenses.

In some embodiments of this aspect of the disclosure, when the illuminating light sheet is configured to illuminate the biological sample at an angle of less than 90° between a tangential plane of the biological sample and the illuminating light sheet, a solid, liquid or gas having a refractive index of about that of the biological sample can be disposed between the biological sample and the illuminating and receiving lenses.

In some embodiments of this aspect of the disclosure, the excitation light source can further comprise a shortpass filter to select the excitation wavelength.

In some embodiments of this aspect of the disclosure, the excitation light source can be a laser.

In some embodiments of this aspect of the disclosure, the excitation light source can emit an excitation light having a wavelength of between about 785 nm and 2400 nm. In some embodiments of this aspect of the disclosure, the detector can be sensitive to light having a wavelength of between about 800 nm and about 2400 nm.

In some embodiments of this aspect of the disclosure, the detector can be an InGaAs camera sensitive to light having a wavelength of between about 800 nm and about 2400 nm.

In some embodiments of this aspect of the disclosure, the detector can be a small bandgap semiconductor-based camera sensitive to light having a wavelength of between about 800 nm to about 2400 nm.

As mentioned above, compounds of the present disclosure and pharmaceutical compositions can be used in combination of one or more other therapeutic agents for treating viral infection and other diseases. For example, compounds of the present disclosure and pharmaceutical compositions provided herein can be used in combination with other anti-viral agents to treat viral infection.

While embodiments of the present disclosure are described in connection with the Examples and the corresponding text and figures, there is no intent to limit the disclosure to the embodiments in these descriptions. On the contrary, the intent is to cover all alternatives, modifications, and equivalents included within the spirit and scope of embodiments of the present disclosure.

### EXAMPLES

### Example 1

NIR-II fluorescence probes: Organic nanofluorophore p-FE dye PEGylated core-shell quantum dots PbS/CdS CSQD (FIGS. 7A-7D), ErNPs, and an organic renal excretable TT dye were used. p-FE was comprised of organic dyes trapped in amphiphilic polymeric micelles approximately 12 nm in size measured by dynamic light scattering (Wan et al., Nat. Commun. 9: 1171 (2018). The PEGylated PbS/CdS CSQD was developed recently exhibiting a wide range of excitation wavelength spanning from UV to about 1300 nm, high brightness, biocompatibility and liver excretion (Zhang et al., Proc. Natl. Acad. Sci. USA 115: 6590-6595 (2018)). The ErNPs described in Zhong et al., Nat. Commun. 8: 737 (2017)) have a narrow absorption spectrum around 980 nm. For a typical conjugation, 50 μL prepared PbS/CdS CSQD and 50 μL streptavidin (1 mg/mL in PBS, ProSpec) were added to 450 μL MES solution (10 mM, pH=6.5). 60 μL EDC (65 mM in water) was freshly prepared, and added dropwise to the solution. The solution was stirred at room temperature for 3 hr. Unreacted streptavidin was removed by a centrifugal filter (cutoff=100 k). The final product (referred to PbS/CdS-streptavidin) was suspended in 100 μL PBS buffer.

150 μg anti-mouse PD-1 (BioXCell; cat. #: BE0146; clone RMP1-14) was dissolved in 300 μL PBS buffer. 6 μL EZ-LINK® Sulfo-NHS-LC-Biotin (1.7 mg/mL in DMSO) was added to the solution, and the solution was stirred at room temperature for 1.5 hr. Unreacted biotin was removed by a centrifugal filter (cutoff=100 k). The final product (referred to anti-mouse-PD-1-biotin) was suspended in 100 μL PBS buffer.

Prepared PbS/CdS-streptavidin and anti-mouse-PD-1-biotin was mixed, and stirred at room temperature for 2 hr. Excess antibody was removed by a centrifugal filter (cutoff=300 k). Similar method was used to conjugate anti-mouse/human-CD11 b (BioXCell; cat. #: BE0007; clone M1/70) to PbS/CdS CSQD. The TT dye (Zhang et al., Adv. Mater. 28: 6872-6879 (2016) exhibits similar spectroscopic properties as the p-FE dye with an excitation at approximately 785 nm and emission of approximately 1000-1200 nm. The TT dye contains an azide group that can be used for conjugation to PD-L1 antibodies by click chemistry for molecular imaging. Purified anti-mouse-PD-L1 antibody was purchased from Selleckchem. Conjugation was through copper-free click chemistry using linker DBCO-PEG4-NHS (Click Chemistry Tools).

### Example 2

NIR-II light sheet microscope system: As show in FIG. 6A, individual lasers with wavelengths of 658 nm, 785 nm or 1319 nm were directed into a spatial filter comprising two achromatic lenses (L3 and L4) and a 50-μm pinhole (PH), generating illumination with maximum excitation powers of 1.7 mW, 11.9 mW and 8.2 mW at the front side of objective respectively.

This spatial filter improved the circularity and quality of the illumination beam to generate a uniform light sheet across the field of view. The excitations could be selected by removable mirrors (M2-M4).

Excitation power was measured by a laser power meter (3A-SH, NOVA II, OPHIR). Before the laser entering a cylindrical lens (CL), a vertically arranged adjustable mechanical slit parallel to the CL was used to adjust the span range of light sheet along Y-axis direction (FIG. 6A). A pair of achromatic lenses (L1, L2) and another slit (S1) was used for adjusting the effective numerical aperture of the objective 01 before the light was focused on the back focal plane of illumination objective 01 to form the light sheet illumination.

For in vivo imaging, the actual excitation intensity illuminated on the target mouse was approximately 0.8 W cm⁻², approximately 1.1 W cm⁻² and approximately 3.4 W cm⁻² the for 658 nm, 785 nm and 1319 nm laser, respectively, which is below the safety limit for laser exposure shorter than 10 s (658 nm: 1.1 W cm⁻²; 785 nm: 1.6 W cm⁻², 1319 nm: 5.5 W cm⁻²).

For the oblique LSM (FIGS. 4E and 6B), the optical path was the same as the typical LSM as shown in FIG. 6A. However, the illumination objective and the detection objective were arranged at 45° to samples, as shown in FIG. 6B. A UV fused silica right-angle prism was used in oblique LSM.

The light sheet was positioned to pass through a tissue sample or a tumor protrusion on a mouse or flat mouse head, fluorescence imaging was done by focusing on and normal to the light sheet plane through a detection objective (02) and a 200-mm tube lens, using a liquid-nitrogen-cooled InGaAs camera (2D-OMA V, Princeton Instruments) or a water-cooled InGaAs camera (Ninox 640, Raptor Photonics) after filtered by selected emission filters. The focal lengths of L1, L2, L3, L4 were 60 mm, 100 mm, 30 mm and 60 mm, respectively. All the optical components were made by Thorlabs. For illumination objective, a 5× objective (N.A=0.15, Nikon LU Plan) or a 10× objective (N.A=0.25, Bausch & Lomb Optical Co.) was used. For imaging, a 4× objective (N.A=0.1, Bausch & Lomb Optical Co.), a 10× objective (N.A=0.25, Bausch & Lomb Optical Co.), or a 50× objective (NA=0.6, Nikon CF Plan) was used.

### Example 3

Light sheet shape, resolution and field of view considerations: Two orthogonal slits were mounted in the illumination arm to adjust the light sheet shape by changing the effective numerical aperture NA and the span range along Y-axis direction (FIG. 6A). To observe the light sheet propagation in glycerol, water, intralipid or brain, the cylindrical lens was rotated by 90° and S1 was adjusted to control the light sheet spanning along vertical direction and S2 was used to control the actual numerical aperture (NA) of illumination. This allowed the formation of light sheets with adjustable waist thickness and Raleigh length to balance imaging resolution and field of view (FOV). When 10× illumination and 50× detection objectives were used, the effective NA of illumination was adjusted to be about 0.17. For 5× illumination and 4× or 10× detection objectives, the effective NA of illumination was adjusted to be about 0.039 or about 0.051, respectively.

The effective NA was estimated using NA=n sin α=n sin(arctan(D/2f)), where n is the refractive index, α is the half of aperture angle, D is the illumination width of light sheet (adjusted by slit S1 for LSM imaging) as it exiting the illumination objective, and f is the focal length of illumination objective. At a given width of slit S1, D was measured experimentally by putting a scattering paper close to the aperture of the illumination objective. D was adjusted by S2 when the cylindrical lens was rotated by 90° for imaging the side view of the light sheet (FIGS. 12A-12C). The measured light sheet waist and Rayleigh length were consistent with those from theoretical estimations based on the effective NA values (FIGS. 12A-12C).

The resolution of NIR-II LSM is limited by the diffraction limit and scattering that still existed in NIR-II (FIG. 1F). The diffraction limited resolution along Z for 10×, 0.25-NA detection objectives was 14.8 μm (850-1000 nm), 18.4 μm (1100-1200 nm) and 25.6 μm (1500-1700 nm) estimated by nλ/NA. The value of 25.6 μm was larger than the measured LS thickness (FIGS. 12A-12C). Therefore, resolution along Z was set by LS thickness under this condition, which was about 10 μm (FIGS. 12A-12C).

Using the 0.5-NA 50× detection objective, the diffraction limited resolution along Z was 2.6 μm (850-1000 nm), 3.2 μm (1100-1200 nm), and 4.4 μm (1500-1700 nm). These analysis suggested that the Z resolution of the current NIR-II LSM is down to about 10 μm, suitable for single-cell resolution along Z.

X-Y diffraction limited resolution was higher, about 2.3 μm (850-1000 nm), 2.8 μm (1100-1200 nm) and 3.9 μm (1500-1700 nm) using the 10×, 0.25-NA detection objective; and 0.9 μm (850-1000 nm), 1.2 μm (1100-1200 nm) and 1.6 μm (1500-1700 nm) using the 50×, 0.6-NA detection objective (estimated by Rayleigh criteria, 0.61λ/NA).

The LS waist and Rayleigh length are contradicting factors, optimizing one means degrading performance in the other. The selecting actual NA for each experiment were tradeoffs of these two parameters to obtain uniform LS that are as thin as possible across a large enough FOV. The actual NA and corresponding waist and confocal length for each data set were summarized in Table 2.

### Example 4

Light sheet microscopy 3D volumetric imaging/scanning: For 3D normal NIR-II LSM imaging (FIG. 6A), as the imaging depth changed, an obvious misalignment of light sheet and working plane of the imaging objective appeared due to refractive index mismatch of the air and tissue. This was compensated by a linear movement of detection objective (FIGS. 9A-9C and 10) concurrent with sample Z position change. The sample scanning in Z and detection objective Z compensation movement was realized by a 3D translation stage (KMTS50E, Thorlabs) and a single-axis translation stage (MTS50-Z8, Thorlabs), respectively (FIGS. 9A-9C).

Different detection windows were selected by using corresponding long-pass and short-pass filters. Synchronous control of 3D translation stage movement and image record was realized using LabView software through a data acquisition card (NI USB-6008, National Instruments).

For oblique LSM (FIG. 6B), the lateral movement for 3D imaging was realized by a translation stage (M-VP-25XL, Newport) and another acquisition card (NI USB-6210) was used. The original images recorded by camera in oblique LSM were 45° to lateral direction (FIG. 4E). The original data to XYZ axes in ImageJ/Fiji was transformed by using the function of affine transform (shear, scaling and rotation).

Maximum intensity projections (FIGS. 3A-3C) and 3D rendering was performed using ImageJ. Multi-color fluorescence images were also merged in ImageJ.

### Example 5

Mouse handling and tumor xenograft: C57BL/6 and BALB/c female mice were from Charles River. 4-6-week-old C57BL/6 (or BALB/c) mice were shaved using hair removal lotion and inoculated with about 1 million MC38 (or CT 26) cancer cells on the right flank of back near the hind limb or on the ear for tumor growth. The sample sizes of mice were selected based on previously reported studies. Mice were randomly selected from cages for all experiments. During in vivo imaging, all mice were anaesthetized by a rodent anesthesia machine with 2 l min⁻¹ O₂ gas mixed with 3% isoflurane.

### Example 6

Ex vivo NIR-II light sheet microscopy of mouse brains: For ex vivo LSM of mouse brains in various NIR-1 and NIR-II regions (FIGS. 1C, 2E, 8-10D, and 16A-16F), C57BL/6 mice were firstly injected with 200 μL of p-FE with O.D.=4 at 808 nm, followed by injection of 200 μL PEGylated PbS/CdS CSQD (O.D.=4 at 808 nm) at 5 min post injection of p-FE. The mouse was sacrificed at 30 min post injection under anesthesia, and brain tissues were taken out and fixed with 10% neutral buffered formalin at room temperature. After washing in PBS twice, the fixed mouse brain was preserved in glycerol at 4° C. for further imaging. Fixing and glycerol treatment induced a partial tissue clearing effect with the imaging depth increased to about twice of that in a non-cleared brain.

For NIR-II imaging mouse brains (FIGS. 2A and 3A), C57BL/6 mice were injected with 200 μL PEGylated PbS/CdS CSQD (O.D.=4 at 808 nm) and sacrificed at 30 min post injection. The brain tissues were taken out and fixed with 10% neutral buffered formalin at room temperature. After washing in PBS twice, the fixed mouse brain was preserved in glycerol at 4° C. for ex vivo imaging.

For a 5× illumination objective and the 4× (FIG. 2A) or 10× (FIGS. 1C, 2E, 8A-10, and 16A-16F) detection objective, the actual NA of illumination was adjusted to be about 0.039 or about 0.051. When a 10× illumination objective and a 50× detection objective were used, the actual NA of illumination was adjusted to be about 0.17 (FIGS. 11A-11D). The corresponding waists for different wavelengths were shown in FIG. 12A-12C. Other detailed experimental conditions, such as Z scanning increment, exposure time, excitation and emission wavelengths, are summarized in Table 2.

### Example 7

In vivo wide-field NIR-II fluorescence imaging: The NIR-II wide-field fluorescence images in FIGS. 4A, 5E, and 17A-17E were recorded using a 2D liquid-nitrogen cooled InGaAs camera (Princeton Instruments, 2D OMA-V, USA) or Ninox 640 (Raptor Photonics). An 808 nm fiber-coupled diode laser (RPMC Lasers, USA) was used as the excitation source and a filter set (850 and 1,000 nm short-pass filter) was applied to filter the excitation light. The actual excitation intensity after passing filters was about 70 mW cm⁻². The fluorescence signal was collected by two achromatic lenses to the InGaAs camera with different magnifications after filtered by corresponding low-pass and long-pass filters. Two-channel fluorescence images were merged in ImageJ.

For three-color wide-field imaging of PD-L1, PD-1 expressing cells and vessels in CT26 tumor bearing BALB/c mouse, 200 μL anti-PD-L1-Er (10 mg/mL) were injected intravenously. After 24 h, 200 μL anti-PD-1-PEGylated PbS/CdS CSQD (O.D.=0.5 at 808 nm) were injected and in another 29 h, 250 μL p-FE (O.D.=5 at 808 nm) was injected into the tail vein.

Wide-field imaging (FIG. 4G) was performed immediately post injection of p-FE. Fluorescence signals of ErNPs and PbS/CdS CSQD (both in 1500-1700 nm range) were differentiated by resolving the vastly different lifetimes of the two probes (about 5 ms for ErNPs, about 20 μs for PbS). Briefly, the 1500-1700-nm fluorescence signal emitted from PbS/CdS CSQD was recorded under CW 808 nm excitation with exposure time of 5 ms, under which no fluorescence emitted from ErNPs due to the lack of absorption at 808 nm. Illumination was then switched to 975 nm pulse for 14 ms excitation. After switching off the excitation and waiting for 1 ms, wide-field imaging only detected 1500-1700-nm fluorescence from ErNPs due to its long emission lifetime of about 5 ms (PbS CSQD about 20 μs) by the InGaAs camera using an exposure time of 20 ms. p-FE probes circulating in vessels were excited by a 808-nm illumination and imaged in 1100-1300 nm with an exposure time of 3 ms.

### Example 8

In vivo NIR-II light sheet microscopy of tumors: For three-plex light sheet imaging of PD-L1, PD-1 expressing cells and vessels in CT26 tumor on BALB/c mouse, 200 μL anti-PD-L1-Er (10 mg/mL) was first injected intravenously. After 24 h, 200 μL anti-PD-1-PEGylated PbS/CdS CSQD (O.D.=0.5 at 808 nm) was injected. In another 29 h, 250 μL p-FE (O.D.=5 at 808 nm) was injected into the tail vein to label the vessels. 2 min post injection of p-FE, non-invasive oblique NIR-II LSM (FIGS. 4H-4J) was performed. Duplex PD-L1 and PD-1 were imaged by differentiating fluorescence signals of ErNPs labeled PD-L1 and PbS/CdS CSQD labeled PD-1 (both in 1500-1700 nm range) by resolving the vastly different lifetimes of the two probes (about 5 ms for ErNP and about 20 μs for PbS).

The 1500-1700-nm fluorescence signal emitted from PD-1 labeled by PbS/CdS CSQD was recorded under CW 1319-nm light sheet excitation and 100-ms exposure time, during which no fluorescence emitted from ErNPs due to the lack of absorption at 1319 nm. Then illumination was switched to 14 ms long 975 nm pulse illumination and then switched off. After a wait time of 1 ms, optical sectioning/image recording of 1500-1700-nm fluorescence only detected the long life-time ErNPs for PD-L1 imaging using an exposure time of 100 ms. Fluorescence images recording at every optical sectioning was realized by synchronously controlling a 1319-nm laser, a 975-nm laser, a motorized stage and the camera using Labview software through a data acquisition card (NI USB-6210). Then another scan was performed to record p-FE signal in 1100-1300 nm in vessels with 100-ms exposure. The scanning step was 4 μm along the X direction. The one-step movement required 100 ms and was confined by the stage (M-VP-25XL, Newport).

For results shown in FIGS. 17A-17F, a C57BL/6 mouse bearing a xenograft MC38 tumor on the ear or right/left flank of the back near the hind limb was injected with anti-PD-L1-TT dye or free TT dye. The mouse was used for in vivo light sheet microscopy imaging immediately and at 24 h post injection by placing the mouse on a 3D translation stage (KMTS50E, Thorlabs) after anesthesia. The initial LS illumination position Z below the top of the surface of the protruding tumor was controlled by the 3D motorized translation stage. For monitoring dynamic blood flow at a fixed illumination plane through the tumor (FIG. 4A), the camera began recording with a preset exposure time immediately after p-FE (200 μL, O.D.=4 at 808 nm) or PEGylated PbS/CdS CSQD (200 μL, O.D.=4 at 808 nm) was injected into the tail vein. When the recorded fluorescence images did not show further changes and reached a steady state, 3D light sheet microscopy was performed to volumetrically image the vasculatures or map the distribution of anti-PD-L1-TT in the tumor (FIG. 17E). For dynamic observation of blood flow (FIG. 4A), a 4× imaging objective lens was used. The illumination was generated by a 5× illumination objective with actual NA of about 0.039 (FIGS. 12A-12C). The PD-L1 were profiled using a 10× (FIG. 17E) and a 50× (FIGS. 18B-18E) detection objective. The Z scanning increment, exposure time and excitation and emission wavelengths are summarized in Table 2 in Example 14.

### Example 9

In vivo NIR-II light sheet microscopy of mouse head: To image (FIG. 5A) through the different layers of the head of a 4-week-old BALB/c, the hair was shaved using hair remover lotion and washed with warm water. Then the mouse was intravenously injected with 200 μL PEGylated PbS/CdS CSQD (O.D.=4 at 808 nm). Oblique NIR-II LSM was performed at 2 h and 12 h post injection with a 5× illumination objective and a 10× imaging objective. The mouse was mounted on a home-made stage with heating pad to keep body temperature and imaged in the configuration shown in FIG. 6B.

### Example 10

Traumatic brain injury (TBI): The TBI was performed based on reported procedures with modifications (Zhang et al., Adv. Mater. 28: 6872-6879 (2016)). Briefly, the benchmark stereotaxic impactor was mounted on a stereotaxic frame at 45° (David Kopf Instruments, Tujunga, Calif., USA). Anesthetized mice were placed on a customized foam mold in a prone position. To induce TBI, the tip was driven towards the mouse head at a speed of 4.0-4.5 mm/s, a dwell time of 0.2 s set by the electronic control box, and an impact depth of 3 mm adjusted by the stereotaxic device. After 2 h recovery, the 4-6-week-old C57BL/6 mouse was intravenously injected with 200 μL anti-CD11b-PEGylated PbS/CdS CSQD (O.D.=0.5 at 808 nm) and monitored by wide-field system and oblique NIR-II LSM mounted with a 5× illumination objective and a 10× imaging objective 24 h post injection. The Z scanning increment, exposure time and excitation and emission wavelengths are summarized in Table 2.

### Example 11

Statistics and data analysis: Data analysis was performed in MATLAB 2017 or Origin 9.0. The standard deviation and mean shown in FIGS. 1A-2F, 9A-9C, 11A-11D and 12A-12C were calculated by Origin 9.0. The fitting lines in FIG. 3E were derived by the weighted least-square method in Origin 9.0. For each representative experimental result, the number of successful independent experiments performed on different mice was indicated in the corresponding figure legend.

### Example 12

Study of light sheet propagation in different media: Light sheet propagation in glycerol solutions was studied using light sheets with different NA and excitation wavelengths. Experiments were performed in glycerol containing PEGylated PbS/CdS CSQD uniformly dispersed in glycerol. The emission was collected in 1500-1700-nm window excited by 658 nm, 785 nm and 1319 nm LS illuminations. To directly observe light transmission in glycerol, the cylindrical lens was rotated by 90° and mechanical slits were used to control the NA and the spanning range along Y (FIG. 6A). The illumination plane was rotated by 90° and the light sheet shape can be imaged along the Y direction for its X-Z plane for side view (FIG. 12A). In a transparent medium (FIG. 12A), experimentally measured waist and double Rayleigh range of light sheet were consistent with theoretical estimations (FIGS. 12B and 12C).

To study the propagation of the light sheet with wavelength of 658 nm, 785 nm and 1319 nm in a scattering medium, imaging of LS propagation was performed in intralipid solutions of different concentrations (FIG. 13A). Light scattering was apparent as the intralipid concentration increased from 0.00% to 5.00% when 658 nm or 785 nm excitation was used. 1319-nm LS excitation retained its shape over the longest distance. The light sheet propagation was further simulated in the intralipid phantom by the Monte Carlo method based on the method developed by Wang et al., Comput. Meth. Prog. Bio. 47: 131-146 (1995) using the scattering coefficient μₛ and the anisotropy g estimated by van Staveren et al., (Appl. Opt. 30: 4507-4514 (1991)) and Johns et al., (Opt. Express 13: 4828-4842 (2005)):

μₛ(λ)=0.016λ^{-2.4} (1)

μₛ′=10.094×conc.+0.433 (2)

g(λ)=1.1−0.58λ (3)

where A is the wavelength, μₛ′=μₛ(1−g) is the reduced scattering coefficient and conc. is the concentration of intralipid.

Equations 1 and 3 were only used for 10.00% intralipid solution. The available spectral range of Equation 2 is between 750 nm to 830 nm. The μₛ of 10% intralipid solution was first calculated at different wavelengths using Equation 1. Then the μₛ of 1.25%, 2.50% and 5.00% intralipid solutions was obtained based on the linear relationship between μₛ and concentration of Equation 2 and μₛ′=μₛ(1−g). These parameters are summarized in Table 1.

The illumination waist measured in water at NA=0.039 was used as initial FWHM of incident light in Monte Carlo simulations. The simulated results were consistent with the experimental observations (FIGS. 13A-14L). Generally, the length over which the light sheet transmits by less than 1.414 times the initial waist (w₀) is regarded as the distance useful for imaging. Under this definition, the critical length was larger than 1000 μm for the 1319 nm excitation in 1.25%, 2.5% and 5.0% intralipid solutions, much larger than that of 658 nm and 785 nm cases. Since the scattering coefficient of intralipid can be conveniently adjusted by controlling its concentration, it is a widely used phantom to study photon-material interactions. To study the light sheet propagation in an uniform scattering medium with similar scattering characteristics as mouse brain, simulations were performed using the scattering coefficient of the 2.5% intralipid and anisotropy factor of the brain measured by Shi et al., (J. Biophotonics 9: 38-43 (2016)).

The simulation results were compared with the experimental observations in glycerol-cleared mouse brain in FIGS. 15A-15H. The simulated light propagation in brain was consistent with experimental results of 658 nm, 785 nm and 1,319 nm excitation (FIGS. 15F-15H). The critical distances for uniform illumination were about 210 μm, about 320 μm and about 1000 μm for excitations using 658 nm, 785 nm and 1319 nm light sheet in mouse brain, respectively (FIGS. 15F-15H).

The LS excitation intensity along incident direction is another important parameter for imaging in scattering tissue, as it affects the transmission distance of excitation in the tissue and determines the illumination field. As the intralipid concentration increased, the intensity along propagation direction attenuated faster but the 1319 nm excitation decayed the slowest compared to the 658 nm and 785 nm excitations (FIGS. 14J-14L). Intensity attenuation was influenced by scattering, absorption and anisotropy of tissue. As the brain had larger anisotropy than intralipid, light sheet transmitted longer in the brain (FIGS. 15A (top; middle) and 15C). To study the illumination field of 658 nm, 785 nm and 1319 nm LS in mouse brain, LSM imaging we performed of a brain tissue at a depth of Z about 200 μm along the LS incident direction X for up to 1 cm (FIGS. 2A and 2B). Though photons in the light sheet could propagate as far as about 6000 μm to excite fluorescence in large-diameter vasculatures, it was only in the initial limited distance (FWHM less than 10 μm) that small blood vessels could be observed (FIG. 2A). These limited distances were about 1380 μm, about 1676 μm and about 3900 μm for 658 nm, 785 nm, and 1319 nm excitation respectively as longer excitation attenuated slower in mouse brain.

For high-quality optical sectioning in LSM, both uniform light sheet waist and available illumination field should be ensured across the field of view.

### Example 13

The μₛ, g of intralipid at different concentrations and wavelengths were calculated by Equations 1-3. The scattering coefficient of brain for excitation wavelength was mimicked by 2.5% intralipid and the anisotropy factor of brain was from the value measured by Shi et al., (J. Biophotonics 9: 38-43 (2016)). The μₛ in the various emission wavelengths were extracted from FIG. 3E.

TABLE 1
The scattering coefficient μₛ, anisotropy factor g and mean
free path (MFP, Iₛ) of intralipid of various concentrations and
brain tissue at different excitation and emission wavelengths.

| | | | Intralipid | | | |
|---|---|---|---|---|---|---|
| μₛ (cm⁻¹) | | | 1.25% | 2.50% | 5.00% | Brain |
| Excitation | 658 | nm | 54.625 | 109.250 | 218.500 | 109.250 |
| wavelength | 785 | nm | 36.731 | 73.462 | 146.924 | 73.462 |
| | 1319 | nm | 10.250 | 20.500 | 41.000 | 20.500 |
| Emission | 850-1000 | nm | 20.000- | 40.000- | 80.000- | 32.765 |
| wavelength | | | 29.541 | 59.082 | 118.164 | |
| | 1100-1200 | nm | 12.912- | 25.824- | 51.648- | 22.712 |
| | | | 15.911 | 31.821 | 63.643 | |
| | 1500-1700 | nm | 5.597- | 11.194- | 22.388- | 15.648 |
| | | | 7.558 | 15.116 | 30.232 | |

| | Wavelength nm | | |
|---|---|---|---|
| g | 658 | 785 | 1319 |
| Intralipid | 0.7184 | 0.6447 | 0.3350 |
| Brain | 0.92 | 0.92 | 0.95 |

| | | | Intralipid | | | |
|---|---|---|---|---|---|---|
| Iₛ = 1/μₛ (μm) | | | 1.25% | 2.50% | 5.00% | Brain |
| Excitation | 658 | nm | 183.1 | 91.5 | 45.8 | 91.5 |
| wavelength | 785 | nm | 272.2 | 136.1 | 68.1 | 136.1 |
| | 1319 | nm | 975.6 | 487.8 | 243.9 | 487.8 |
| Emission | 850-1000 | nm | 338.5- | 169.3- | 84.6- | 305.2 |
| wavelength | | | 500.0 | 250.0 | 125.0 | |
| | 1100-1200 | nm | 628.5- | 314.3- | 157.1- | 440.3 |
| | | | 774.5 | 387.2 | 193.6 | |
| | 1500-1700 | nm | 1323.1- | 661.5- | 330.8- | 639.0 |
| | | | 1786.7 | 893.3 | 446.7 | |

### Example 14

TABLE 2
Imaging conditions

| | | | | | scan | | | | |
|---|---|---|---|---|---|---|---|---|---|
| | Contrast | Excitation | Emission | Exposure time | step | O1 | | | |
| | agent | (nm) | (nm) | (s) | (μm) | (Actual NA) | | O2 | |
| FIG. 1C | p-FE | 785 | 850-1,000 | 0.2 | 5 | 5x | (0.039) | 10x | (0.25) |
| (Vasculature) | | | | | | | | | |
| FIG. 1C | p-FE | 785 | 1,100-1,200 | 0.5 | 5 | 5x | (0.039) | 10x | (0.25) |
| (Vasculature) | | | | | | | | | |
| FIG. 1C | PEGylated | 785 | 1,500-1,700 | 0.7 | 5 | 5x | (0.039) | 10x | (0.25) |
| (Vasculature) | PbS/CdS | | | | | | | | |
| | CSQD | | | | | | | | |
| FIG. 2A | PEGylated | 658/785/1,319 | 1,500-1,700 | 0.9/0.7/0.9 | 1000 (X) | 5x | (0.039) | 4x | (0.1) |
| (Vasculature) | PbS/CdS | | | | | | | | |
| | CSQD | | | | | | | | |
| FIG. 2C | PEGylated | 658/785/1,319 | 1,500-1,700 | 0.2/0.1/0.2 | / | 5x | (0.039) | 4x | (0.1) |
| (Intralipid) | PbS/CdS | | | | | | | | |
| | CSQD | | | | | | | | |
| FIG. 2E | PEGylated | 658/785/1,319 | 1,500-1,700 | 0.9/0.7/0.9 | 5 | 5x | (0.039) | 10x | (0.25) |
| (Vasculature) | PbS/CdS | | | | | | | | |
| | CSQD | | | | | | | | |
| FIG. 3A, 3B | PEGylated | 1,319 | 1,500-1,700 | 0.8 | / | 5x | (0.051) | 4x | (0.1) |
| (Vasculature) | PbS/CdS | | | | | | | | |
| | CSQD | | | | | | | | |
| FIG. 3C | p-FE | 785 | 850-1,000 | 0.2 | 5 | 5x | (0.039) | 10x | (0.25) |
| (Vasculature) | | | | | | | | | |
| FIG. 3C | p-FE | 785 | 1,100-1,200 | 0.5 | 5 | 5x | (0.039) | 10x | (0.25) |
| (Vasculature) | | | | | | | | | |
| FIG. 3C | PEGylated | 785 | 1,500-1,700 | 0.7 | 5 | 5x | (0.039) | 10x | (0.25) |
| (Vasculature) | PbS/CdS | | | | | | | | |
| | CSQD | | | | | | | | |
| FIGS. 4A, 4C | p-FE | 785 | 1,000-1,200 | 0.8 | 5 | 5x | (0.039) | 4x | (0.1) |
| (Blood flow) | | | | | | | | | |
| FIG. 4F | anti-PD-1- | 1,319 | 1,500-1,700 | 0.04 | / | 5X | (0.039) | 10X | (0.25) |
| (PD-1) | PEGylated | | | | | | | | |
| | PbS/CdS | | | | | | | | |
| | CSQD | | | | | | | | |
| FIG. 4G | anti-PD-L1- | 975 | 1,500-1,700 | 0.02 | / | / | | / | |
| (Tumor) | Er | | | | | | | | |
| FIG. 4G | anti-PD-1- | 1,319 | 1,500-1,700 | 0.005 | / | / | | / | |
| (Tumor) | PEGylated | | | | | | | | |
| | PbS/CdS | | | | | | | | |
| | CSQD | | | | | | | | |
| FIG. 4G | p-FE | 785 | 1,100-1,300 | 0.003 | / | / | | / | |
| (Vessels) | | | | | | | | | |
| FIG. 4H-J | anti-PD-L1- | 975 | 1,500-1,700 | 0.1 | 4 | 5X | (0.039) | 10X | (0.25) |
| (Tumor) | Er | | | | | | | | |
| FIG. 4H-J | anti-PD-1- | 1,319 | 1,500-1,700 | 0.1 | 4 | 5X | (0.039) | 10X | (0.25) |
| (Tumor) | PEGylated | | | | | | | | |
| | PbS/CdS | | | | | | | | |
| | CSQD | | | | | | | | |
| FIG. 4H-J | p-FE | 785 | 1,100-1,300 | 0.1 | 4 | 5X | (0.039) | 10X | (0.25) |
| (Vessels) | | | | | | | | | |
| FIG. 5A-C | PEGylated | 1,319 | 1,500-1,700 | 0.04 | 4 | 5X | (0.039) | 10X | (0.25) |
| (Head) | PbS/CdS | | | | | | | | |
| | CSQD | | | | | | | | |
| FIG. 5F | anti-CD11b- | 1,319 | 1,500-1,700 | 0.1 | 4 | 5X | (0.039) | 10X | (0.25) |
| (Macrophage/ | PEGylated | | | | | | | | |
| microglia) | PbS/CdS | | | | | | | | |
| | CSQD | | | | | | | | |
| FIG. 8A | PEGylated | 785 | 1,500-1,700 | 0.8 | 5 | 5x | (0.039) | 10x | (0.25) |
| (Vasculature) | PbS/CdS | | | | | | | | |
| | CSQD | | | | | | | | |
| FIG. 9A, 9B | p-FE | 785 | 850-1,000 | 0.45 | 5 | 5x | (0.039) | 10x | (0.25) |
| (Vasculature) | | | | | | | | | |
| FIG. 9C | p-FE | 785 | 1,100-1,200 | 0.6 | 5 | 5x | (0.039) | 10x | (0.25) |
| (Vasculature) | | | | | | | | | |
| FIG. 9C | PEGylated | 785 | 1,500-1,700 | 0.6 | 5 | 5x | (0.039) | 10x | (0.25) |
| (Vasculature) | PbS/CdS | | | | | | | | |
| | CSQD | | | | | | | | |
| FIG. 10 | p-FE | 785 | 850-1,000 | 0.45 | 5 | 5X | (0.039) | 10X | (0.25) |
| (Vasculature) | | | | | | | | | |
| FIG. 10 | p-FE | 785 | 1,100-1,200 | 0.6 | 5 | 5X | (0.039) | 10X | (0.25) |
| (Vasculature) | | | | | | | | | |
| FIG. 10 | PEGylated | 785 | 1,500-1,700 | 0.6 | 5 | 5X | (0.039) | 10X | (0.25) |
| (Vasculature) | PbS/CdS | | | | | | | | |
| | CSQD | | | | | | | | |
| FIGS. 16A-16F | PEGylated | 658/785/1,319 | 1,500-1,700 | 0.9/0.7/0.9 | 5 | 5x | (0.039) | 10x | (0.25) |
| (Vasculature) | PbS/CdS | | | | | | | | |
| | CSQD | | | | | | | | |
| FIGS. 17B-17D | PEGylated | 808 | 1,500-1,700 | 0.005 | / | / | | / | |
| (Vasculature) | PbS/CdS | | | | | | | | |
| | CSQD | | | | | | | | |
| FIG. 17B | TT | 808 | 1,000-1,200 | 0.005 | / | / | | / | |
| (Tumor) | | | | | | | | | |
| FIG. 17C, 17D | anti-PD-L1- | 808 | 1,000-1,200 | 0.005 | / | / | | / | |
| (Tumor) | TT | | | | | | | | |
| FIG. 17E | PEGylated | 1,319 | 1,500-1,700 | 0.8 | 3 | 5X | (0.051) | 10X | (0.25) |
| (Vasculature) | PbS/CdS | | | | | | | | |
| | CSQD | | | | | | | | |
| FIG. 17E | anti-PD-L1- | 785 | 1,000-1,200 | 0.8 | 3 | 5X | (0.039) | 10X | (0.25) |
| (Tumor) | TT | | | | | | | | |
| FIG. 18A | PEGylated | 785 | 1,500-1,700 | 0.8 | 5 | 5x | (0.039) | 4x | (0.1) |
| (Vasculature) | PbS/CdS | | | | | | | | |
| | CSQD | | | | | | | | |
| FIG. 18A | TT | 785 | 1,000-1,200 | 0.2 | 5 | 5x | (0.039) | 4x | (0.1) |
| (Tumor) | | | | | | | | | |
| FIGS. | anti-PD-L1- | 785 | 1,000-1,200 | 0.5 | 1 | 5x | (0.106) | 50x | (0.6) |
| 18B, 18D | TT | | | | | | | | |
| (Tumor) | | | | | | | | | |
| FIGS. | PEGylated | 1,319 | 1,500-1,700 | 0.5 | 1 | 5x | (0.106) | 50x | (0.6) |
| 18C, 18E | PbS/CdS | | | | | | | | |
| (Vasculature) | CSQD | | | | | | | | |

### Example 15

An animation was constructed with images taken at various depth Z in mouse brain tissue by NIR light sheet microscopy under the same 785 nm excitation while detecting emissions in NIR-1 (850-1000 nm, p-FE), NIR-IIa (1100-1200 nm, p-FE) and NIR-IIb (1500-1700 nm, PEGylated PbS/CdS CSQD probes) respectively (as shown in FIG. 10). With a 785 nm light sheet, it was seen that the brain tissue imaging depth limit increased, background signal decreased and SBR increased at longer detection wavelength from 850-1000 nm to 1100-1200 nm and 1500-1700 nm. The imaging depth limit (defined as the tissue depth at which the SBR decreased to approximately 2) increased from Z_{SBR=2} approximately 1.0 mm to approximately 2.0 mm and approximately 2.5 mm as emission wavelength increased from approximately 850 nm to approximately 1100 nm and approximately 1700 nm.

### Example 16

NIR light sheet images in the X-Y plane taken at various depth Z in mouse brain tissue by detecting 1500-1700 nm emission of PbS/CdS core-shell quantum dots in vessels under various excitations using 658 nm, 785 nm and 1319 nm light sheets respectively. Such imaging utilized an important property of quantum dots, i.e., ultra-wide excitation ranges (ultraviolet to greater than 1300 nm, FIG. 6). In the recorded field of view, these three light sheets could still allow imaging of small vessels (FWHM less than 10 μm). Suppressed scattering of longer wavelength LS was gleaned from the X-Y images taken at various Z, with improved SBR and reduced FWHM of feature sizes especially at deeper depths.

### Example 17

NIR light sheet images in the X-Z plane (Yin the range of 0-640 μm with 5 μm increasement) reconstructed from X-Y images at various depth Z in mouse brain tissue by detecting 1500-1700 nm emission (PbS/CdS core-shell quantum dots) under various excitations using 658 nm, 785 nm and 1319 nm light sheets respectively. Suppressed scattering of longer wavelength LS was gleaned from X-Z cross sectional images, with reduced FWHM of feature sizes along the depth Z direction, corresponding to higher vertical resolution and better sectioning capability along Z.

### Example 18

Ex vivo NIR-II Light sheet microscopy images of vasculatures in mouse brain as shown in FIG. 3A. The volumetric imaging was done using an unusually long 1319 nm excitation and 1500-1700 nm detection for PbS/CdS core-shell quantum dots in brain vasculatures. A video reconstructed 3D images of brain tissue taken with 3 μm Z increment in depth and with various tissue volumes. The excitation power (approximately 8 mW) and the exposure time (0.8 s) were kept constant during entire sectioning. A 10× detection objective and a 5× illumination objective were used. Light sheet microscopy with both excitation and emission in the 1000-1700 nm NIR-II window minimized scattering and maximized the resolution, penetration depth and field of view.

### Example 19

In vivo time-course LSM imaging of blood perfusion into tumor vasculatures by recording the p-FE nanofluorophore (200 μL, O.D.=4 at 808 nm, 785 nm excitation, 1000-1200 nm detection) signals immediately following intravenous injection into the mouse tail-vein. For imaging, light sheet sections were made through the tumor (at a fixed plane and below the top of the xenograft MC38 tumor of approximately 8 mm in diameter) at a depth of Z of approximately 300 μm. Imaging was recorded through the same plane at approximately 1 fps. The LS illumination position Z was controlled by a 3D motorized translation stage. A 4× detection objective and a 5× illumination objective were used. Blood flows in tumor vasculatures were found irregular and intermittent with turning-on and shutting-off behavior, oscillatory/fluctuating flowing patterns and even flow direction reversal in the same vasculature in a tumor.

### Example 20

In vivo light sheet microscopy of anti-PD-L1-TT and vasculatures in a MC38 xenograft tumor on a mouse for the data in FIG. 17F. The anti-PD-L1-TT probes (red color, excitation: 785 nm, emission: 1000-1200 nm) were first injected intravenously. 24 h later, PEGylated PbS/CdS CSQD (green color, excitation: 1319 nm, emission: 1500-1700 nm) was injected and 10 min later, two-color LSM imaging of anti-PD-L1-TT and CSQD were performed for molecular imaging of PD-L1 in tumor and tumor vasculatures surrounding the PD-L1. A 10× detection objective and a 5× illumination objective were used. The Z increment in depth was 3 μm. Discrete anti-PD-L1-TT dye labelled features inside tumors were resolved with cellular resolution. Meanwhile, irregular tumor blood vessels were seen engulfing PD-L1 expressing cells. The results suggested extravasated anti-PD-L1-TT dye specifically targeting PD-L1 expressing cells in the tumor.

### Example 21

TABLE 3
Examples of excitation and emission wavelengths

| | |
|---|---|
| Excitation | Emission |

| | | |
|---|---|---|
| 785 | nm | >1000 nm |
| 785 | nm | >1500 nm |
| 785 | nm | >1300 nm |
| 808 | nm | >1000 nm |
| 808 | nm | >1300 nm |
| 808 | nm | >1500 nm |
| 980 | nm | >1000 nm |
| 980 | nm | >1300 nm |
| 980 | nm | >1500 nm |
| 1319 | nm | >1350 nm |
| 1319 | nm | >1500 nm |
| 1540 | nm | >1580 nm |
| 1540 | nm | >1800 nm |

What is claimed:

1. A method of optically sectioning a biological sample, the method comprising the steps:
(a) contacting a biological sample with a fluorescent contrast agent having an excitation wavelength of between about 785 nm to about 2400 nm and a fluorescence emission having a wavelength of between about 800 nm to about 2400 nm;
(b) irradiating the biological sample with at least one excitation light having a wavelength of between about 785 nm to about 2400 nm, wherein the excitation light is configured as a static light sheet and directed through a first plane of the biological sample;
(c) orthogonally detecting an emitted fluorescence having a wavelength of between about 800 nm to about 2400 nm from the irradiated biological sample; and
(d) generating a first digital image of the fluorescence from the irradiated first plane through the biological sample.

2. The method of claim 1, wherein the biological sample is an isolated cell or population of isolated cells, a cultured cell or population of cultured cells, an isolated tissue or organ, or an animal or human subject.

3. The method of claim 1, wherein the biological sample has raised features and the irradiated biological sample is imaged by transmitting the light sheet through the raised feature from a side thereof and detecting the emitted fluorescence at right angles to the plane of the illuminating light sheet.

4. The method of claim 1, wherein substantially planar regions of the irradiated biological sample are illuminated by the light sheet at an angle with respect to the normal to the planar region and the emitted fluorescence is detected at right angles to the plane of the illuminating light sheet.

5. The method of claim 1, wherein the fluorescent contrast agent is administrated by vascular delivery to a tissue or organ of the animal or human subject.

6. The method of claim 1, wherein the fluorescent contrast agent is conjugated to a targeting ligand that can specifically bind to a molecular target.

7. The method of claim 6, wherein the targeting ligand has an affinity for a molecular target and is selected from an antibody, a peptide, an aptamer, or a nucleic acid.

8. The method of claim 6, wherein the targeting ligand is an antibody or fragment thereof selectively binding to an epitope of a polypeptide selected from the group consisting of: Programmed cell death protein 1 (PD-1) Programmed death-ligand 1 (PD-L1), and CD11b.

9. The method of claim 1, wherein the fluorescent contrast agent emits at a wavelength of between about 900 to about 2400 nm is an organic molecular dye, a conjugated polymeric dye, a polymer micelle-wrapped organic nanofluorophore, a carbon nanotube, a quantum dot, or a rare-earth down-conversion or up-conversion nanoparticle.

10. The method of claim 1, further comprising the steps:
(i) repeating steps (b)-(d), thereby irradiating a plurality of parallel planes perpendicular to the light sheet plane at various depths through the biological sample, and generating a plurality of digital images; and
(ii) digitally combining the plurality of digital images to generate a three-dimensional image of the location of the fluorescence emitted by the contrast agent in the biological sample.

11. The method of claim 1, wherein the excitation light is delivered to the biological sample by an illumination objective, wherein the numerical aperture (N.A) of the objective is configured to deliver the excitation light as a light sheet having a balanced waist thickness of between about 5 μm to about 20 μm and a Rayleigh length of between about 0.1 mm to about 6.0 mm.

12. The method of claim 1, wherein the excitation light is generated by a laser having a wavelength of between about 700 nm and about 2400 nm.

13. A light sheet microscope comprising along an optical axis:
an illumination objective positioned to direct an excitation light sheet through a plane of a biological sample;
a plurality of achromatic lenses optimized for transmission of light between about 785 nm to about 2400 nm;
a proximal first adjustable mechanical slit;
a cylindrical lens;
a distal second adjustable mechanical slit adjacent to the cylindrical lens and distal to the illumination objective, wherein the slit of said second slit is orientated at right-angles to the slit of the first slit;
a pinhole;
at least one excitation light source in the 600-2400 nm range; and
at least one removable mirror disposed to direct an excitation light from the at least one light source along the optical axis of the illumination objective, the plurality of achromatic lenses, the proximal first adjustable mechanical slit, the cylindrical lens, the distal second adjustable mechanical slit, and the pinhole;
a detection objective disposed to orthogonally receive fluorescent light emitted from a target irradiated by a light sheet from the illumination objective and to direct said fluorescent light to a detector operably connected to a computer system for generating a digital image of the fluorescent light; and
at least one emission filter configured to only transmit fluorescent light having a wavelength of between about 785 nm to about 2400 nm.

14. The light sheet microscope of claim 13, further comprising a right-angle prism disposed between the biological sample and the illuminating and receiving lenses.

15. The light sheet microscope of claim 13, wherein, when the illuminating light sheet is configured to illuminate the biological sample at an angle of less than 90° between a tangential plane of the biological sample and the illuminating light sheet, a solid, liquid or gas having a refractive index of about that of the biological sample is disposed between the biological sample and the illuminating and receiving lenses.

16. The light sheet microscope of claim 13, wherein the excitation light source further comprises a shortpass filter to select the excitation wavelength.

17. The light sheet microscope of claim 11, wherein the excitation light source is a laser.

18. The light sheet microscope of claim 11, wherein the excitation light source emits an excitation light having a wavelength of between about 785 nm and 2400 nm.

19. The light sheet microscope of claim 11, wherein the detector is sensitive to light having a wavelength of between about 800 nm and about 2400 nm.

20. The light sheet microscope of claim 11, wherein the detector is an InGaAs camera sensitive to light having a wavelength of between about 800 nm and about 2400 nm.

21. The light sheet microscope of claim 11, wherein the detector is a small bandgap semiconductor-based camera sensitive to light having a wavelength of between about 800 nm to about 2400 nm.
